(19) United States
(12) Patent Application Publication
(10) Pub. No.: US 2020/0092108 A1
(43) Pub. Date: Mar. 19, 2020

(54) DATA COMMUNICATION METHOD, DEVICE AND APPARATUS, AND STORAGE MEDIUM

(71) Applicant: Alibaba Group Holding Limited, Grand Cayman (KY)

(72) Inventor: Jianwen Lyu, Zhejiang (CN)

(73) Assignee: Alibaba Group Holding Limited

(21) Appl. No.: 16/684,463

(22) Filed: Nov. 14, 2019

Related U.S. Application Data
(63) Continuation of application No. PCT/CN2018/086782, filed on May 15, 2018.

(30) Foreign Application Priority Data
May 26, 2017 (CN) 201710385733.5

(51) Int. Cl. H04L 9/32

(52) U.S. Cl. CPC H04L 9/3247; H04L 9/3242

(57) ABSTRACT

A method including receiving a data request and performing device authentication based on the data request; sending a session parameter after the device authentication is successful, the session parameter comprising a session identifier and a communication key; establishing a persistent connection based on the session identifier; and receiving encrypted service data through the persistent connection, and parsing the encrypted service data based on the communication key. Data is transmitted without the need of reconnection, thereby effectively reducing resource consumption. Moreover, the data is parsed by using the communication key, thereby guaranteeing the data security.

### CROSS REFERENCE TO RELATED PATENT APPLICATIONS

This application claims priority to and is a continuation of PCT Patent Application No. PCT/CN2018/086782, filed on 15 May 2018 and entitled “DATA COMMUNICATION METHOD, DEVICE AND APPARATUS, AND STORAGE MEDIUM,” which claims priority to Chinese Patent Application No. 201710385733.5, filed on 26 May 2017 and entitled “DATA COMMUNICATION METHOD, DEVICE AND APPARATUS, AND STORAGE MEDIUM,” which are incorporated herein by reference in their entirety.

### TECHNICAL FIELD

The present disclosure relates to the technical field of computer technologies, and, more particularly, to data communication methods, apparatuses, electronic devices, servers, and storage media.

### BACKGROUND

The Internet of Things (IoT) may be regarded as the Internet connecting things. In the field of the IoT, massive devices of low power consumption need to interact with cloud servers. These devices are often resource-constrained, that is, the devices merely have a small amount of memory space and a limited computing power. There may be potential safety hazards of communication in a process of data transmission between the devices and the cloud. For example, hackers make hijack network requests to tamper data packets or replay data packets to attack.

When the devices interact with the cloud servers, the reconnections of the network environment where these resource-constrained devices are located are frequent, which will result in increased resource burden of the devices. Moreover, in order to ensure secure data transmission, one approach is to use a Transport Layer Security (TLS) certificate and burn certificate information on each device. This approach has a high safety factor but consumes a large amount of resources during reconnection and handshake each time, which will further increase the resource burden of the devices.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The example embodiments of the present disclosure provide methods for data communication to guarantee secure communication for resource-constrained devices. Correspondingly, the example embodiments of the present disclosure further provide apparatuses, electronic devices, servers, and storage media for data communication to ensure implementation and application of the above-mentioned methods.

In order to solve the above problems, an example embodiment of the present disclosure discloses a method for data communication, including receiving a data request and performing device authentication based on the data request; sending a session parameter after the device authentication is successful, the session parameter including a session identifier and a communication key; establishing a persistent connection based on the session identifier; and receiving encrypted data such as service data through the persistent connection, and parsing the encrypted data based on the communication key.

An example embodiment of the present disclosure further discloses a method for data communication including sending a request for device authentication, and receiving a session parameter after device authentication is successful, the session parameter including a session identifier and a communication key; establishing a persistent connection based on the session identifier; and transmitting, through the persistent connection, data such as service data encrypted by using the communication key.

An example embodiment of the present disclosure further discloses a method for data communication including receiving a request and performing authentication based on the request; sending a session parameter after the authentication is successful, the session parameter including a session identifier and/or a secret key; establishing a connection based on the session parameter; and receiving encrypted data through the connection, and parsing the encrypted data based on the session parameter.

An example embodiment of the present disclosure further discloses a method for data communication including sending a session parameter, the session parameter including a session identifier and/or a secret key; establishing a connection based on the session parameter; and receiving encrypted data through the connection, and parsing the encrypted data based on the session parameter.

An example embodiment of the present disclosure further discloses an apparatus for data communication including a request authenticating module configured to receive a data request and perform device authentication based on the data request; a responding module configured to send a session parameter after the device authentication is successful, the session parameter including a session identifier and a communication key; a persistent connection establishing module configured to establish a persistent connection based on the session identifier; and a data parsing module configured to receive encrypted data such as service data through the persistent connection, and parse the encrypted data such as encrypted service data based on the communication key.

An example embodiment of the present disclosure further discloses an apparatus for data communication including a request sending module configured to send a request for device authentication, and receive a session parameter after device authentication is successful, the session parameter including a session identifier and a communication key; an establishing module configured to establish a persistent connection based on the session identifier; and a data transmitting module configured to transmit, through the persistent connection, data such as service data encrypted by using the communication key.

An example embodiment of the present disclosure further discloses an apparatus for data communication including an authenticating module configured to receive a request and perform authentication based on the request; a sending module configured to send a session parameter after the authentication is successful, the session parameter including a session identifier and/or a secret key; a connection establishing module configured to establish a connection based on the session parameter; and an parsing module configured to receive encrypted data through the connection, and parse the encrypted data based on the session parameter.

An example embodiment of the present disclosure further discloses an apparatus for data communication including a parameter sending module configured to send a session parameter, the session parameter including a session identifier and/or a secret key; a connection establishing module configured to establish a connection based on the session parameter; and a receiving and decrypting module configured to receive encrypted data through the connection, and parse the encrypted data based on the session parameter.

An example embodiment of the present disclosure further discloses a system for data communication including an electronic device and a server. The electronic device includes the apparatus for data communication according to any of the example embodiments of the present disclosure that sends the request for device authentication; and the server includes the apparatus for data communication according to any of example embodiments of the present disclosure that receives the request and performs authentication based on the request.

An example embodiment of the present disclosure further discloses an electronic device, including one or more processors; and one or more computer readable media storing computer-readable instructions thereon, wherein the computer-readable instructions, when executed by the one or more processors, causes the electronic device to implement the methods according to one or more example embodiments of the present disclosure.

An example embodiment of the present disclosure further discloses one or more computer readable media storing computer-readable instructions thereon, wherein the computer-readable instructions, when executed by one or more processors, causes an electronic device to implement the methods according to one or more example embodiments of the present disclosure.

An example embodiment of the present disclosure further discloses a server including one or more processors and one or more computer readable media storing computer-readable instructions thereon, wherein the computer-readable instructions, when executed by the one or more processors, causes the server to implement the methods according to one or more example embodiments of the present disclosure.

An example embodiment of the present disclosure further discloses a device including one or more processors and one or more computer readable media storing computer-readable instructions thereon, wherein the computer-readable instructions, when executed by the one or more processors, causes the device to implement the methods according to example embodiments of the present disclosure.

An example embodiment of the present disclosure further discloses one or more computer readable media storing computer-readable instructions thereon, wherein the computer-readable instructions, when executed by one or more processors, causes a device to implement the methods according to example embodiments of the present disclosure.

An example embodiment of the present disclosure further discloses one or more computer readable media storing computer-readable instructions thereon, wherein the computer-readable instructions, when executed by one or more processors, causes a device to implement the method according to example embodiments of the present disclosure.

Compared with conventional techniques, the example embodiments of the present disclosure have at least the following technical advantages. In the example embodiments of the present disclosure, device authentication is performed based on a data request, thereby determining a trusted device. After the device authentication is successful, a session parameter is sent, which includes a session identifier and a communication key. Then a persistent connection is established based on the session identifier. Therefore, data communication is maintained through the persistent connection, and data transmission is carried out without reconnection, thus effectively reducing the resource consumption. Moreover, encrypted service data transmitted through the persistent connection is parsed by using the communication key, thus ensuring the data security.

### BRIEF DESCRIPTION OF THE DRAWINGS

In order to illustrate the technical solutions in the example embodiments of the present disclosure more clearly, the following briefly describes the accompanying drawings which aid in describing the example embodiments. Apparently, the accompanying drawings in the following description merely show some of the example embodiments of the present disclosure, and persons of ordinary skill in the art may derive other drawings from these accompanying drawings without creative efforts.

FIG. 1 is a schematic diagram of an interactive system according to an example embodiment of the present disclosure;

FIG. 2 is a step flowchart at a server side according to an example embodiment of a method for data communication of the present disclosure;

FIG. 3 is a step flowchart at an electronic device side according to an example embodiment of a method for data communication of the present disclosure;

FIG. 4 is a step flowchart at an electronic device side according to an example embodiment of another method for data communication of the present disclosure;

FIG. 5 is a schematic diagram of a communication message according to an example embodiment of the present disclosure;

FIG. 6 is a step flowchart at a server side according to an example embodiment of another method for data communication of the present disclosure;

FIG. 7 is a schematic structural diagram of device interaction according to an example embodiment of the present disclosure;

FIG. 8 is a schematic diagram of interaction between an electronic device and a server according to an example embodiment of the present disclosure;

FIG. 9 is a step flowchart of an example method for data communication according to an example embodiment of the present disclosure;

FIG. 10 is a step flowchart of another example method for data communication according to an example embodiment of the present disclosure;

FIG. 11 is a structural block diagram of an example embodiment of an apparatus for data communication of the present disclosure;

FIG. 12 is a structural block diagram of an alternative example embodiment of an apparatus for data communication of the present disclosure;

FIG. 13 is a structural block diagram of an example embodiment of another apparatus for data communication of the present disclosure;

FIG. 14 is a structural block diagram of an alternative example embodiment of another apparatus for data communication of the present disclosure;

FIG. 15 is a structural block diagram of an example apparatus for data communication in an example embodiment of the present disclosure;

FIG. 16 is a structural block diagram of another example apparatus for data communication in an example embodiment of the present disclosure;

FIG. 17 is a schematic diagram of a hardware structure of a device provided by an example embodiment of the present disclosure; and

FIG. 18 is a schematic diagram of a hardware structure of a device provided by another example embodiment of the present disclosure.

### DETAILED DESCRIPTION

In order to make the above objectives, features, and advantages of the present disclosure more apparent, the present disclosure will be further described below in detail in conjunction with the accompanying drawings and the specific example embodiments.

Example embodiments of the present disclosure may be applied to various scenarios of interaction between an electronic device and a server. As an example, when applied to the field of the IoT, the electronic device is an IoT device. The IoT device may communicate with a Cloud server to perform, for example, data exchange, management, and control. The IoT devices are various electronic devices of an IoT system. These electronic devices may support functions in at least one aspect of audio, video, or data, such as a smart home device, a smart kitchen appliance, a security device, or an in-vehicle device. Different electronic devices have different device performances. Some devices have good performances, such as a good storage capacity and a good computing power; however, some electronic devices have poor performances with restricted resources, that is, the electronic devices merely have a little memory space with a limited computing power. Therefore, in a process of interaction between the electronic devices and servers, consideration should be given not only to data security, but also to performances of the electronic devices themselves. The method for data communication provided by the present disclosure communicates with a server by using a persistent connection after device authentication is successful and transmits service data in an encrypted way, which may not only reduce the resource consumption caused by repeated reconnection, but also ensure the data security.

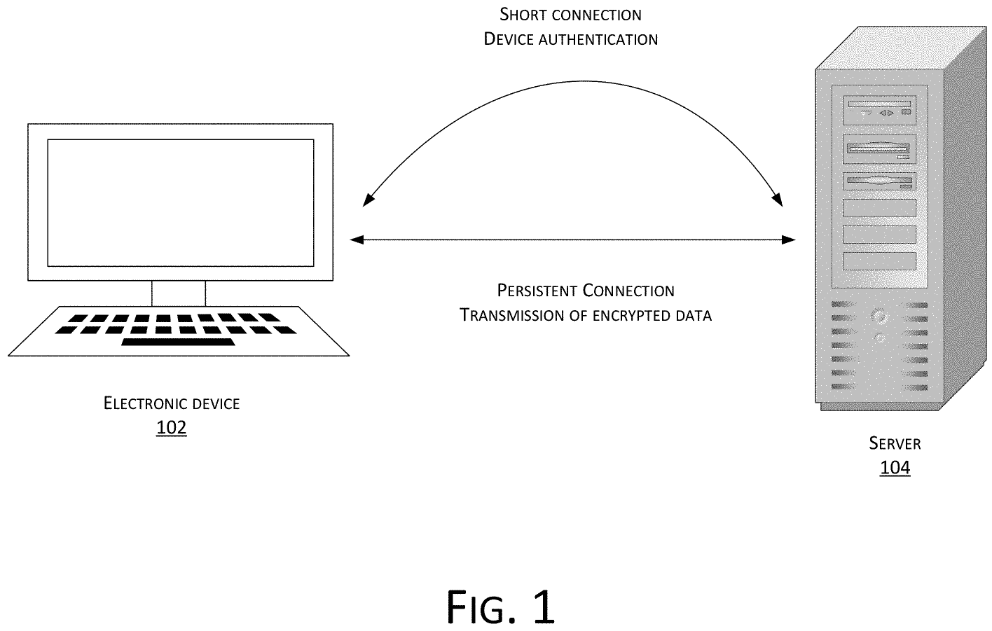

Referring to FIG. 1, a schematic diagram of an interactive system according to an example embodiment of the present disclosure is shown.

The interaction system includes an electronic device 102 and a server 104, wherein the server 104 may be one server, or a server cluster composed of a plurality of servers.

The electronic device 102 may exchange a communication key with the server 104 initially through a short connection, to facilitate subsequent secure communication interaction through a persistent connection. That is, the electronic device 102 may generate a data request. The data request carries parameters for device authentication, such as a signature or other data. The server 104 performs device authentication based on the data request, and obtains a session parameter after the authentication is successful. The session parameter is a parameter required by a persistent connection session, and may include a session identifier and a communication key. A session identifier (or token) is an identifier of an established persistent connection session, and verifies whether the connection is trusted. The communication key is a secret key for communication interaction between the electronic device 102 and the server 104, which may generate and verify a signature, and may further encrypt and decrypt data such as service data. The server 104 generates response information corresponding to the data request and carrying the session parameter, and then sends the response information to the electronic device 102.

The electronic device 102 correspondingly obtains the session parameter from the response information, and then may establish a persistent connection with the server 104 by using the session identifier, that is, send a session establishment message to the server 104 based on the session identifier. The server 104 verifies the session identifier based on the session establishment message, and establishes the persistent connection session between the server 104 and the electronic device 102 after the verification is successful. Then, encrypted data such as encrypted service data may be transmitted between the electronic device 102 and the server 104. The data such as the service data may be encrypted and decrypted via the communication key.

Therefore, at first, authentication with a server is performed through a short connection. Then a device communicates with the server by using a persistent connection after device authentication is successful, and encrypted data is transmitted by using the persistent connection, which may not only reduce the resource consumption caused by repeated reconnection, but also ensure the data security.

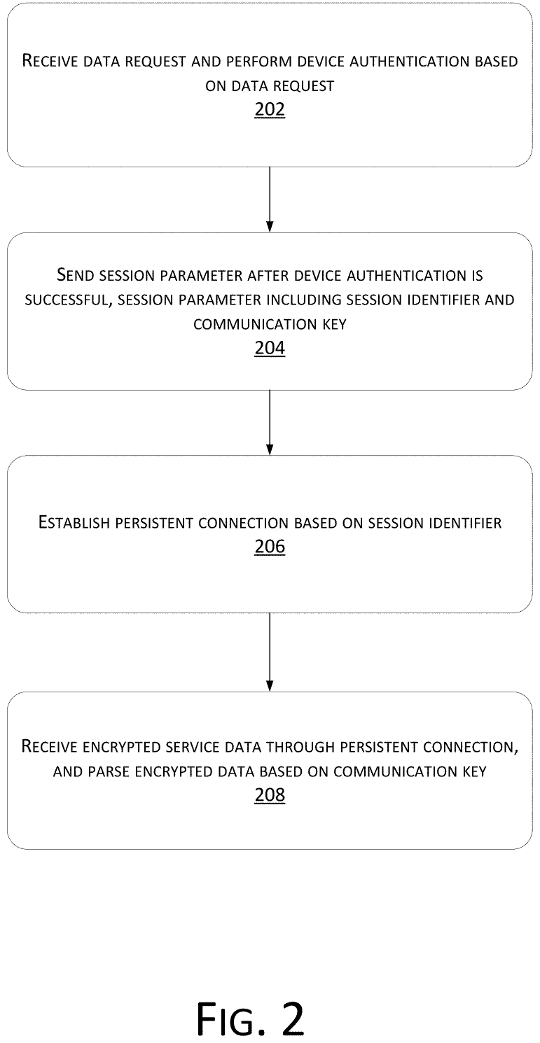

Referring to FIG. 2, a step flowchart at a server side according to an example embodiment of a method for data communication of the present disclosure is shown, which may include the following steps:
Step 202: receiving a data request and performing device authentication based on the data request.
Step 204: sending a session parameter after the device authentication is successful, the session parameter including a session identifier and a communication key.
Step 206: establishing a persistent connection based on the session identifier.
Step 208: receiving encrypted service data through the persistent connection, and parsing the encrypted data such as the encrypted service data based on the communication key.

A cloud server may receive the data request of an electronic device, such as a request of the electronic device for device authentication, and then obtain a request parameter from the data request to perform the device authentication, for example, obtain a device signature to perform the device authentication. After the device authentication is successful, it is confirmed that the electronic device is a trusted device, the session identifier and the communication key may be obtained based on certain rules, for example, by randomly assigning a session identifier, and obtaining a communication key from a database. Then, by taking the session identifier and the communication key as session parameters, response information carrying the session parameters is generated in response to the data request, and then the response information is sent to the corresponding electronic device.

The server may receive a session establishment message where the electronic device requests for establishing the persistent connection, and then may establish a persistent connection session between the server and the electronic device after determining, based on the session identifier in the session establishment message, that the current connection is trusted. Then, the encrypted service data may be transmitted between the electronic device and the server. The service data may be encrypted and decrypted via the communication key. That is, after receiving the encrypted service data through the persistent connection, the server may parse the encrypted service data, by, such as, verifying a signature, or decrypting the data, thereby obtaining corresponding service data, and continuing to execute subsequent processing.

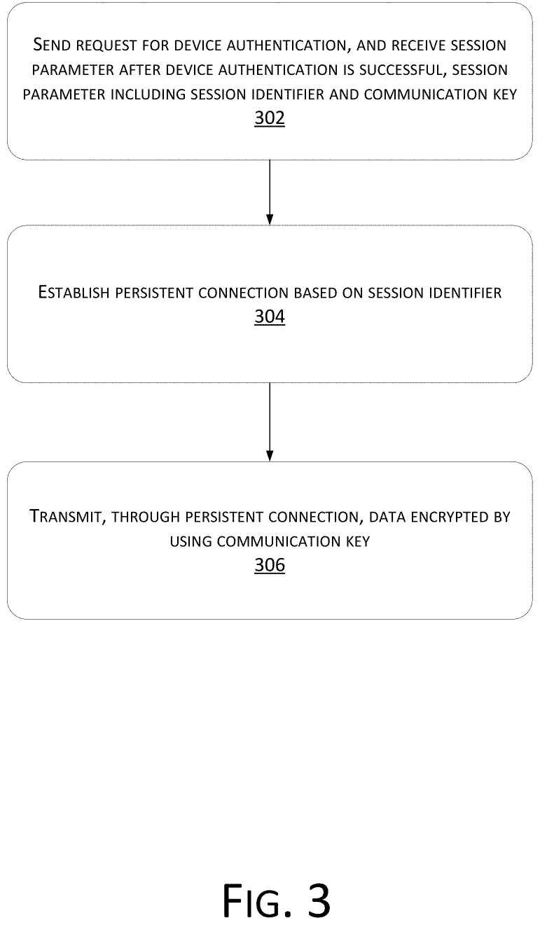

Referring to FIG. 3, a step flowchart at an electronic device side according to an example embodiment of a method for data communication of the present disclosure is shown, which may include the following steps:
Step 302: sending a request for device authentication, and receiving a session parameter after device authentication is successful, the session parameter including a session identifier and a communication key.
Step 304: establishing a persistent connection based on the session identifier.
Step 306: transmitting, through the persistent connection, data such as service data encrypted by using the communication key.

The electronic device may generate a data request, such as a request for device authentication. The request for device authentication is used for requesting device authentication, and obtaining a session parameter required for the persistent connection. Therefore, the request for device authentication may carry request parameters, such as a signature, such that a server performs device authentication to determine that the electronic device is a trusted device. Therefore, after the device authentication of the server is successful, response information may be returned, and the electronic device may obtain the session parameter from the response information. The session parameter includes the session identifier and the communication key. Then, a session establishment message is generated based on the session identifier, and is sent to the server to establish a persistent connection session. After the persistent connection is successfully established, the service data may be encrypted and decrypted based on the communication key, and transmitted through the persistent connection. For example, the service data is encrypted by using the communication key, and then transmitted to the server through the persistent connection.

For example, device authentication may be performed based on a data request, thereby determining a trusted device, and after the device authentication is successful, a session parameter is sent, the session parameter here includes a session identifier and a communication key, then a persistent connection may be established based on the session identifier; therefore, data communication is maintained through the persistent connection, and data transmission is carried out without reconnection, thus effectively reducing the resource consumption; moreover, encrypted service data transmitted through the persistent connection may be parsed by using the communication key, thus ensuring the service data security.

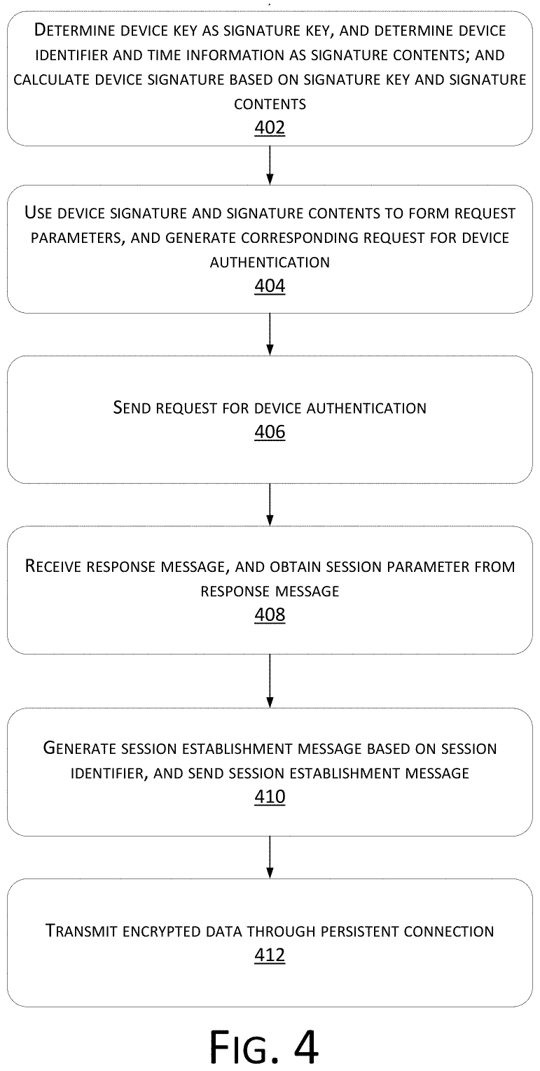

Referring to FIG. 4, a step flowchart at an electronic device side according to an example embodiment of another method for data communication of the present disclosure is shown, which may include the following steps:
Step 402: determining a device key as a signature key, and determining a device identifier and time information as signature contents; and calculating a device signature based on the signature key and the signature contents.
Step 404: using the device signature and the signature contents to form request parameters, and generating a corresponding request for device authentication.
Step 406: sending the request for device authentication.

For example, the electronic device may obtain the device key, the device identifier, the time information, and the like, wherein the device key, which may be called “deviceSecret,” is a secret key corresponding to an electronic device, e.g., a private key; and the device identifier, which may be called “deviceId,” is a unique identifier of the electronic device. The device key and the device identifier may be preset in a chip of the electronic device. The time information may be a sequential number, which may be called “seqNum”, such as a time stamp. The example embodiment of the present disclosure may calculate a signature by using various signature algorithms. For example, for the calculating a device signature, the device key may be used as a signature key, and the device identifier and the time information may be used as the signature contents, and then the device signature is calculated based on the signature key and the signature contents, which facilitates subsequent device authentication based on the device signature. The request for device authentication requesting a server for session may be generated, and the device signature and the signature contents (i.e., the device identifier and the time information) may be used to constitute the request parameters which are added to the request for device authentication. Then, the request for device authentication is sent to the server. Thus, the server may use the device identifier and the time information as the signature contents, and obtain the device key as the signature key to calculate the signature and verify whether the signature is identical to the device signature.

For example, the device signature is signA, the device identifier is deviceId, the time information is timestamp, and the device key is deviceSecret. Then, the signature key=deviceSecret, signature content=deviceId & timestamp, and signA=hmac (key, content). Thus, the device signature may be calculated, and the device identifier and the time information may be added to the request for device authentication by a plaintext, such that the server side performs device authentication based on the device signature. hmac algorithm stands for Hashed or Hash based Message Authentication Code. It is a result of work done on developing a MAC derived from cryptographic hash functions. For other examples, some other encryption algorithm may be used herein.
Step 408: receiving response information, and obtaining a session parameter from the response information.

Therefore, after the authentication of the server side is successful, the response information may be generated based on the session parameter, and the electronic device may obtain the session parameter, i.e., a session identifier and a communication key, from the response information after receiving the response information.
Step 410: generating a session establishment message based on the session identifier, and sending the session establishment message.

Then, the session establishment message may be generated based on the session identifier. The session establishment message may carry information, such as device information, and the session identifier, and then the session establishment message is sent. The session establishment message may be a message that is sent when a session is initially established, or a message when the session is reconnected after disconnection, wherein the session may be disconnected due to network or other problems. The session establishment message here may carry the device information, such as a MAC address or other information of a device, or carry a session identifier “token”, or carry some to-be-encrypted data.

Then, the server may perform validation based on the parameter in the session message, for example, to validate whether the session identifier is accurate, and for another example, to validate whether the device information corresponding to the session identifier is consistent. After determining that the validation is successful, a persistent connection may be established between the electronic device and the server, i.e., a corresponding TCP (Transmission Control Protocol) transmission channel is established.
Step 412: transmitting encrypted service data through the persistent connection.

After the persistent connection is established, the server and the electronic device may perform transmission interaction of the encrypted service data. That is, the electronic device may send the encrypted service data to the server, and may also receive the encrypted service data sent by the server.

The electronic device here may encrypt service data by using the communication key, and then transmit the encrypted service data through the persistent connection, including: determining a corresponding message signature based on a communication parameter of the service data and the communication key; encrypting the service data in accordance with an encryption algorithm, and using the encrypted service data and the message signature to constitute a communication message; and transmitting the communication message through the persistent connection. To-be-transmitted service data may be obtained and transmitted by using the communication message. Thus, the communication parameter, such as data length, of the service data may be determined, the communication key in the session parameter may be further obtained, and then the corresponding message signature may be generated based on the communication parameter and the communication key. And, the service data may be encrypted by using the communication key in accordance with the encryption algorithm to obtain the encrypted service data. Then, the encrypted service data and the message signature are used to constitute the communication message, and certainly, the communication parameter that may be used for verifying the message signature may also be added to the communication message.

The determining a corresponding message signature based on a communication parameter of the service data and the communication key includes: using the communication parameter of the service data and the time information as the signature contents, and using the communication key as the signature key; and calculating the corresponding message signature based on the signature key and the signature contents. The obtained communication parameter of the service data may include data of a queue to which a service belongs, which may be called as “topic”, a length of the service data, which may be called as “length”, and the like. The time information, such as the time stamp, may further be obtained, and the communication parameter and the time information may be used as the signature contents. The communication key may also be used as the signature key, and then the corresponding message signature may be calculated based on the signature key and the signature contents. For example, the time information is seqNum, and the time stamp may be used. hmac is a signature algorithm preventing messages from being tampered. The signature contents here are signed original values, i.e., content=topic+seqNum+length (service data length), key=signature key, and the message signature signB=hmac (key, content).

The encrypting the service data in accordance with an encryption algorithm, and using the encrypted service data and the message signature to constitute the communication message includes: encrypting the service data by using the communication key in accordance with the encryption algorithm to obtain the encrypted service data; and adding the encrypted service data to the communication message, and adding the message signature, the communication parameter, and the time information to effective positions (which may be called “payload”) of the communication message. The example embodiment of the present disclosure may preset an encryption algorithm and a decryption algorithm, e.g., a symmetric encryption algorithm, and may encrypt the service data by using the communication key in accordance with the encryption algorithm, to obtain the corresponding encrypted service data. Then, the encrypted service data may be added to the communication message, and then the message signature, the communication parameter, and the time information may be added to the payload of the communication message.

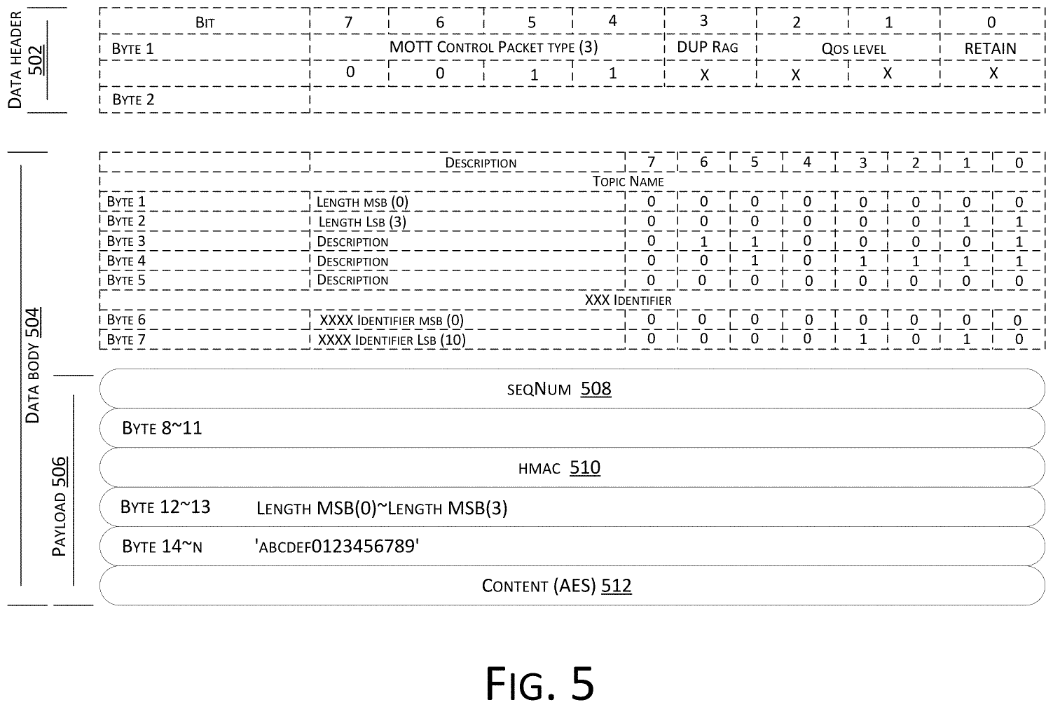

An example of a communication message is shown in FIG. 5. The communication message includes a data header 502 and a data body 504, wherein the communication message may use a dynamically variable length algorithm, i.e., the communication message has a variable length. FIG. 5 is merely an example, and does not limit the length of the communication message. The data body 504 at least includes encrypted service data and a payload 506. The payload 506 is used for carrying relevant parameters of service data, thereby facilitating the validation of the communication message. As shown in the example of FIG. 5, the payload 506 carries time information “seqNum” 508, a message signature “hmac” 510, and a signature content “content” 512 of the message signature. Therefore, a second verification signature may be calculated based on the signature content “content” 512 and a stored communication key to verify whether the message signature is accurate. Whether the communication message is a received message may be further verified based on the time information “seqNum” 508.

In the example embodiment of the present disclosure, the communication key may be one secret key, that is, the same communication key is used for both processing the message signature and encrypting/decrypting the service data; or the communication key may be two secret keys, that is, the message signature is generated and verified by using one secret key (which may be referred to as a first communication key), while the service data is encrypted/decrypted by using another secret key (which may be referred to as a second communication key).

The electronic device may further receive the encrypted service data sent by a server, i.e., the communication message, and verify the message signature of the communication message based on the communication key; and decrypt the communication message by using the communication key after the signature verification is successful. The communication message may be received, then the time information, the communication parameter, and the like may be obtained from the payload of the communication message, the communication key corresponding to the electronic device is then obtained, and then the corresponding signature content and a signature key may be determined to calculate the verified signature, perform authentication based on the verified signature and the message signature, and decrypt the service data in the communication message after the authentication is successful. If the authentication is not successful, the communication data may be discarded. Thus, the encrypted communication between the electronic device and the server may be implemented based on the persistent connection, and the data security may be guaranteed on the basis of reducing resource consumption.

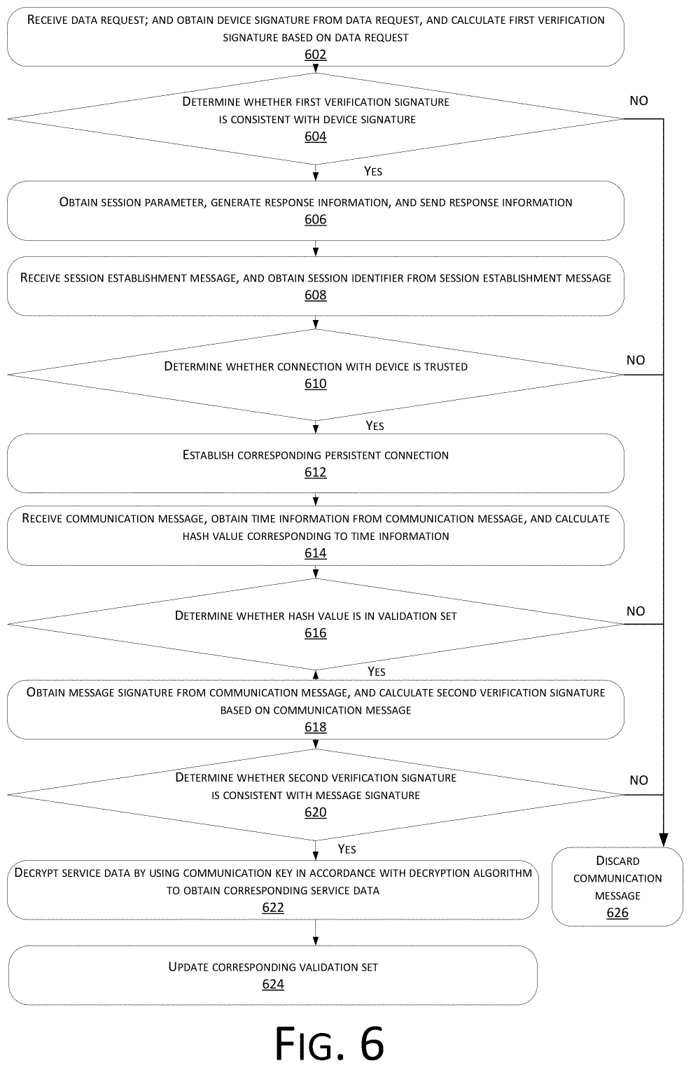

Referring to FIG. 6, a step flowchart at a server side according to an example embodiment of another method for data communication of the present disclosure is shown, which may include the following steps:
Step 602: receiving a data request; and obtaining a device signature from the data request, and calculating a first verification signature based on the data request.

A server may receive the data request of an electronic device, then obtain the device signature from the data request, and obtain a signature content and other data to calculate a first verification signature for verifying the device signature. The calculating a first verification signature based on the data request includes: obtaining a device identifier and time information from the data request; using the device identifier and the time information as signature contents, and obtaining a device key as a signature key; and calculating the first verification signature based on the signature key and the signature contents. The device identifier and the time information are obtained from the data request, the device identifier and the time information are used as the signature contents, a pre-stored device key corresponding to the device identifier is obtained, the device key is used as the signature key, and then the first verification signature may be calculated based on the signature key and the signature contents using a signature algorithm consistent with that at the electronic device side.
Step 604: determining whether the calculated first verification signature is consistent with the obtained device signature.

The calculated first verification signature is compared with the device signature obtained from the data request, to determine whether the calculated first verification signature is consistent with the device signature obtained from the data request. If the first verification signature is consistent with the obtained device signature, step 606 is executed; and if the first verification signature is not consistent with the obtained device signature, step 626 is executed.
Step 606: obtaining a session parameter, generating response information, and sending the response information.

If the first verification signature is consistent with the device signature, the device validation being successful is determined. A session identifier and a communication key assigned for the electronic device may be obtained, the session identifier and the communication key are used as session parameters, device response information is generated based on the session parameters, and the response information is sent.
Step 608: receiving a session establishment message, and obtaining the session identifier from the session establishment message.
Step 610: determining whether a connection with the electronic device is trusted based on the session identifier.

The server side may send the session establishment message to the server based on the session parameter. The server may obtain the session identifier and other message establishment parameters, such as device information, and a signature, from the session establishment message, validate whether the session identifier is accurate, determine corresponding validation information based on the session identifier, and determine whether the validation information is identical to the device information, the signature, and the like.

For example, the device information includes device mac and other information, the session identifier is token, and encrypted information of a message, mqttpassWord=encrypted (deviceId=xxx&timestamp=xxx&sign=xxx). After the server successfully parses information, based on a communication key associated with the token, passWord is decrypted successively, then validity of the deviceId and the sign is verified, and after the verification is successful, a TCP transmission channel is established. Otherwise, the connection is refused.

If the verification is successful, then a connection of the electronic device being trusted is determined, and step 612 is executed; and if the verification is not successful, then the connection of the electronic device not being trusted is determined, and step 626 is executed.
Step 612: establishing a corresponding persistent connection.

After the connection of the electronic device being trusted is determined, the validation being successful is determined, and then the persistent connection between the electronic device and the server may be established, i.e., the corresponding TCP transmission channel is established.

After the persistent connection is established, the server and the electronic device may perform transmission interaction of the encrypted service data. That is, the electronic device may send the encrypted service data to the server, and the server may also send the encrypted service data to the electronic device.

Taking the server receiving encrypted data sent by the electronic device as an example, the server may parse the communication message by a method including at least one of the following steps: decrypting the encrypted service data; validating a message signature of the communication message; and performing replay validation on the communication message to validate whether the communication message is a received message. During the transmission of the communication message, some communication messages may be hijacked, and then the messages are tampered or a replay attack is made. The replay attack here means that an attacker sends a packet having been received by a destination host, to achieve the purpose of passing authentication, and deceiving the system, and may be used for destroying the authentication security during identity authentication. That is, the system may receive a repeatedly sent communication message. The communication message may be caused by the replay attack, or other reasons. However, it is not necessary to repeatedly receive and store a received message. The present example embodiment determines whether the communication message is a received message by replay validation, thereby discarding repeatedly received messages, and retaining unreceived messages. Moreover, whether the communication message is tampered may be detected by parsing, signature validation, or the like, thereby preventing the system security problems caused by tampering messages. When at least two of the above three steps are executed, their execution sequence is not limited. The present example embodiment provides an example where playback validation is first executed, followed by signature validation, and then data decryption.

The playback validation includes the following steps 614-616, and 626.
Step 614: receiving a communication message, obtaining time information from the communication message, and calculating a hash value corresponding to the time information.
Step 616: determining whether the hash value is in the validation set.

Whether the communication message is a received message may be validated based on time information of a payload of the communication message, for example, determining whether the time information is accurate, and whether there were service data at the same time before. In the present example embodiment, retransmission validation may be performed based on the hash value corresponding to the time information. A validation set “bloomFilter” may be set in a memory of the server. The validation set may be used for detecting whether an element is a member of the set, and has very good space and time efficiency. That is, a certain number of member positions may be set in the validation set, such as 10 member positions from 0 to 9. An initial value (element) of each member position is 0, and the hash values obtained by calculation are also from 0 to 9, thereby determining that the hash values correspond to the member positions in the validation set. For example, a hash value of 1 denotes a 2nd member position, and if the value of the member position is 0, it denotes that this position has no data, that is, the hash value is in the validation set, and then the value of the member position may be set as 1. If the value of the member position is 1, then the value denotes that this position has data, i.e., the hash value is not in the validation set. The hash value may be determined by calculating a hash value, an MD5 value, or the like of the time information.

If the hash value is in the validation set, then step 618 is executed; and if the hash value is not in the validation set, then step 626 is executed.

The signature validation includes the following steps 618-620, and 626.
Step 618: obtaining the message signature from the communication message, and calculating a second verification signature based on the communication message.

Then, the message signature may be obtained from the communication message, and the second verification signature may be calculated based on data of the payload of the communication message. The second verification signature is used for verifying the message signature.

The calculating a second verification signature based on the communication message includes: obtaining a communication parameter and the time information from the communication message; using the communication parameter and the time information as the signature contents, and obtaining the communication key as the signature key; and calculating the second verification signature based on the signature key and the signature contents. The communication parameter and the time information are obtained from the payload of the communication message, then the communication parameter and the time information are used as the signature contents to obtain the communication key of the session identifier corresponding to the communication message, the communication key is used as the signature key, and the second verification signature is then calculated based on the signature key and the signature contents. Therefore, the message signature may be validated to prevent plaintext information in the communication message, such as the time information of the payload, from being tampered, and improve the data security. Step 620: determining whether the calculated second verification signature is consistent with the obtained message signature.

If the second verification signature is consistent with the obtained message signature, then step 622 is executed; and if the second verification signature is not consistent with the obtained message signature, then step 626 is executed.
Step 622: decrypting the service data by using the communication key in accordance with a decryption algorithm to obtain corresponding service data.

The service data is decrypted by using the communication key in accordance with the decryption algorithm corresponding to the encryption algorithm at the electronic device side, to obtain the corresponding service data.
Step 624: updating a corresponding validation set.

In the present example embodiment, if the hash value is in the validation set, then the corresponding validation set may be updated. For example, the value of the corresponding member position is set as 1, and then data of the member position, if retransmitted, will be detected and discarded. The corresponding validation set may be updated after determining that the communication message is not the received message. To ensure the data accuracy, the validation set may also be updated after the verification signature passes the verification and the service data is obtained by decryption.
Step 626: discarding the communication message.

In the present example embodiment, the communication message is discarded after conditions in various scenarios such as device validation, signature validation, trusted validation and data parsing.

In the example embodiment of the present disclosure, a signature or the like may be calculated based on the time information. The time information may be information such as a time stamp. For a communication message transmitted through the persistent connection, the server may further determine, for each session of the electronic device, whether the message is within a time error range, based on the time stamp. The communication message is discarded if the message is beyond the time error range, and processing is continued if the message is within the time error range.

In the example embodiment of the present disclosure, the server may be provided with one or more validation sets “bloomFilter”. For example, if a global validation set is provided, then all services may share the validation set. For another example, each service is provided with a set, and a corresponding validation set is determined, based on a service to which the communication message belongs, to perform replay validation. For still another example, a validation set is provided for each session, thus different validation sets are used for replay validation for different persistent connection sessions.

A member position in the validation set “bloomFilter” is set as 1, that is, a corresponding communication message is received after an element is inserted, and more elements inserted into the validation set “bloomFilter” causes higher probability of wrong determination of “within the set”, because the hash values calculated corresponding to different time information are not unique, i.e., may be identical. The more the elements are inserted, i.e., the more the member positions are filled, the fewer the remaining member positions are, and the higher the probability of obtaining identical hash values by calculation is. In a test scenario, assuming that a capacity of the validation set “bloomFilter” is set as 631 KB (kilobytes), then for a device sending 1000 messages per day, when the device is online for 10 days, i.e., when the validation set “bloomFilter” receives 10,000 messages, a misjudgment rate is 0%; similarly, when the device is online for 100 days, i.e., when the validation set “bloomFilter” receives 100,000 messages, the false rate is 0%; and similarly, when the device is online for 200 days, i.e., when the validation set “bloomFilter” receives 200,000 messages, the false rate is 0.0004%. Therefore, with the increase of the number of received messages, the false rate of the validation set “bloomFilter” will be increased accordingly. In order to ensure the accuracy of the validation set “bloomFilter”, the validation set may be reset after meeting a certain reset condition. A resetting method of the validation set may be determined based on test results in various scenarios and a specific setting method of the validation set “bloomFilter”.

For example, for a global validation set, the reset condition may be determined based on a capacity of the validation set and the total number of communication messages corresponding to various services, received by the server in unit time, thereby resetting the validation set after meeting the reset condition. For example, the reset condition is at most reaching 50% of the capacity of the validation set. For another example, it is determined, based on received data size, that it generally takes 10 days to reach 50% of the capacity of the validation set, and then the reset condition is set as 10 days.

A validation set corresponding to a service may also be similar to the global validation set. The reset condition is determined based on the capacity of the validation set and the total number of communication messages corresponding to the service received by the server in unit time. For example, the reset condition is at most reaching 50% of the capacity of the validation set, or the time when 50% of the capacity of the set is reached, or the like.

For a validation set corresponding to a session, the reset condition may also be determined by the above approaches, i.e., based on the capacity and the number of communication messages, or by other approaches, such as determining the reset condition based on timeliness of the session. A session of the persistent connection generally has timeliness, i.e., a persistent connection corresponding to a session identifier has a connection time threshold, such as 24 h. In an alternative example embodiment of the present disclosure, when reset time of a validation set reaches a time threshold, the validation set is reset. That is, within the valid time of the session of the persistent connection, the reset condition is set as a condition of making a determination based on time, i.e., setting the time threshold of the validation set, such as 10 h, then the reset time of the validation set reaching the time threshold meets the reset condition, and the validation set is reset. Then, the reset time of the validation set is recalculated and is compared with the time threshold. For the timeliness of the persistent connection, it may be controlled by the token via a distributed lock to allow only one login request, and the token has timeliness. For example, the token becomes invalid 24 h later, and the electronic device needs reauthentication.

The server may also encrypt the service data in accordance with the encryption algorithm, and use the encrypted service data and the message signature to constitute the communication message. The corresponding message signature is determined based on the communication parameter of the service data and the communication key; the service data are encrypted in accordance with the encryption algorithm, and the encrypted service data and the message signature are used to constitute the communication message; and the communication message is transmitted through the persistent connection. To-be-transmitted service data may be obtained, and be transmitted by using the communication message. Thus, the communication parameter, such as a data length, of the service data may be determined, the communication key of the session parameter may be further obtained, and then the corresponding message signature may be generated based on the communication parameter and the communication key. And, the service data may be encrypted by using the communication key in accordance with the encryption algorithm to obtain the encrypted service data. Then, the encrypted service data and the message signature are used to constitute the communication message, and certainly, the communication parameter that may be used for verifying the message signature may also be added to the communication message. The determining a corresponding message signature based on a communication parameter of the service data and the communication key includes: using the communication parameter of the service data and the time information as the signature contents, and using the communication key as the signature key; and calculating the corresponding message signature based on the signature key and the signature contents. The server may obtain the communication parameter of the service data, including data “topic” of a queue to which a service belongs, a length of the service data, and the like, may further obtain the time information, such as the time stamp, and may use the communication parameter and the time information as the signature contents. The communication key may also be used as the signature key, and then the corresponding message signature may be calculated based on the signature key and the signature contents. For example, the time information is seqNum, the time stamp may be used, and hmac is a signature algorithm preventing messages from being tampered. The signature contents here are signed original values, i.e., content=topic+seqNum+length (service data length), key=signature key, and the message signature signB=hmac (key, content). The encrypting the service data in accordance with an encryption algorithm, and using the encrypted service data and the message signature to constitute the communication message includes: encrypting the service data by using the communication key in accordance with the encryption algorithm to obtain the encrypted service data; and adding the encrypted service data to the communication message, and adding the message signature, the communication parameter, and the time information to a payload of the communication message. The example embodiment of the present disclosure may preset an encryption algorithm and a decryption algorithm, e.g., a symmetric encryption algorithm, and may encrypt the service data by using the communication key in accordance with the encryption algorithm, to obtain the corresponding encrypted service data. Then, the encrypted service data may be added to the communication message, and then the message signature, the communication parameter, and the time information may be added to the payload of the communication message.

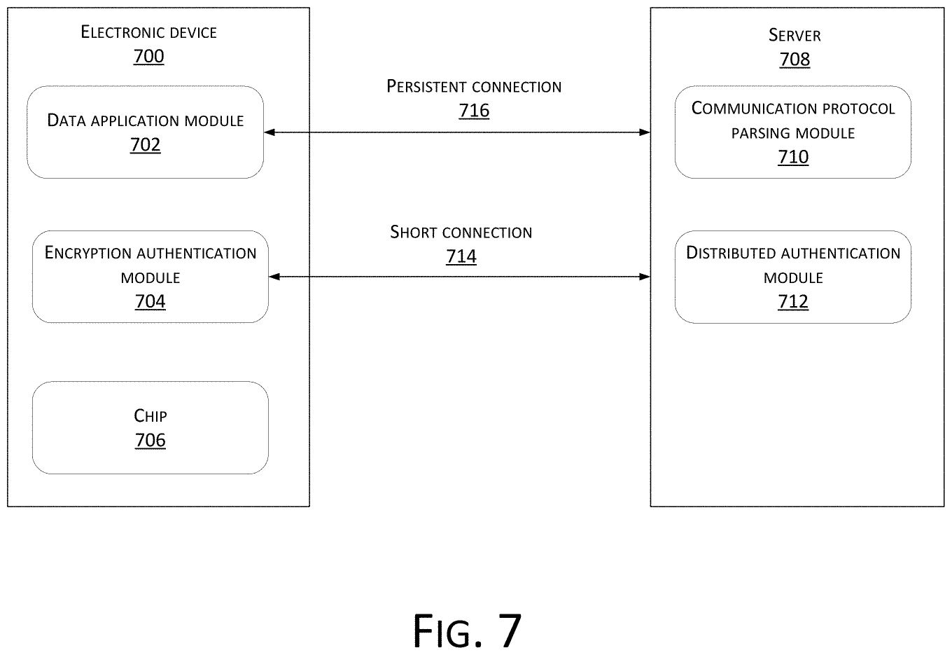

Referring to FIG. 7, a schematic structural diagram of device interaction according to an example embodiment of the present disclosure is shown.

An electronic device 700 includes a data application module 702, an encryption authentication module 704, and a chip 706. For example, the data application module 702 and the encryption authentication module 704 may be stored in the memory (not shown in FIG. 7) of the electronic device 700. A server 708 may include a communication protocol parsing module 710 and a distributed authentication module 712. For example, the communication protocol parsing module 710 and the distributed authentication module 712 may be stored in the memory (not shown in FIG. 7) of the server 708. Certainly, the electronic device 700 and the server 708 may further include other architecture components, which will not be enumerated one by one in the example embodiment of the present disclosure.

For example, the chip 706 is a built-in chip of the electronic device, and may include a read-only register (ROM), and a unique device identifier “deviceId” and a device key “deviceSecret” are burnt thereon when the electronic device 706 was manufactured and left factory. The device key may be a private key, and is generally difficult to hack, and may be self-destroyed after disassembly.

The encryption authentication module 704 is configured to exchange a secret key with the server 708, such as obtaining a communication key by using UDP (User Datagram Protocol) short connection. In the example embodiment of the present disclosure, a short connection 714 between the electronic device 700 and the server 708 may use CoAP (Constrained Application Protocol), and be encrypted based on DTLS (Datagram Transport Layer Security). The encryption authentication module 704 may further provide some security functions, such as a function for obtaining a token of the current session, a function for encrypting a piece of data, a function for decrypting a ciphertext, a function for requesting a signature, and a function for requesting a verification signature.

The data application module 702 is an SDK (Software Development Kit) layer of a service logic. The data application module 702 keeps a persistent connection 716, such as TCP connection, with the server 708, establishes the persistent connection 716 with the server 708 by using the token obtained by the encryption authentication module 704, and performs encryption and decryption by using an encryption authentication module function in subsequent data transmission. The encryption and decryption of service data may be implemented via various algorithms, which may include a symmetric algorithm such as a DES (Data Encryption Standard) algorithm or an asymmetric encryption algorithm such as an AES (Advanced Encryption Standard) algorithm.

The distributed authentication module 712 may be based on RESTful of the CoAP, and the CoAP is more simplified with low requirements for device resources. The token of the current session and a session parameter of an associated communication key may be generated after authentication is successful.

The communication protocol parsing module 710 may be configured to be responsible for session authentication which may be based on TCP. In the session authentication of the example embodiment of the present disclosure, connect message authentication may be performed by using an MQTT (Message Queuing Telemetry Transport) protocol. The authentication message only needs to be sent once during first connection or reconnection, and if service data is directly sent without session authentication, the server 708 may reject the service data.

Encrypted communication interaction between the electronic device and the server may be implemented based on the above-mentioned structure. A stand-alone encryption authentication module is configured, and hardware is provided to improve and guarantee the device key security, so that application modules at upper and intermediate layers of the system are only responsible for data transmission without sensing secret key information, thereby contributing to security protection of delivery processes of different module manufacturers.

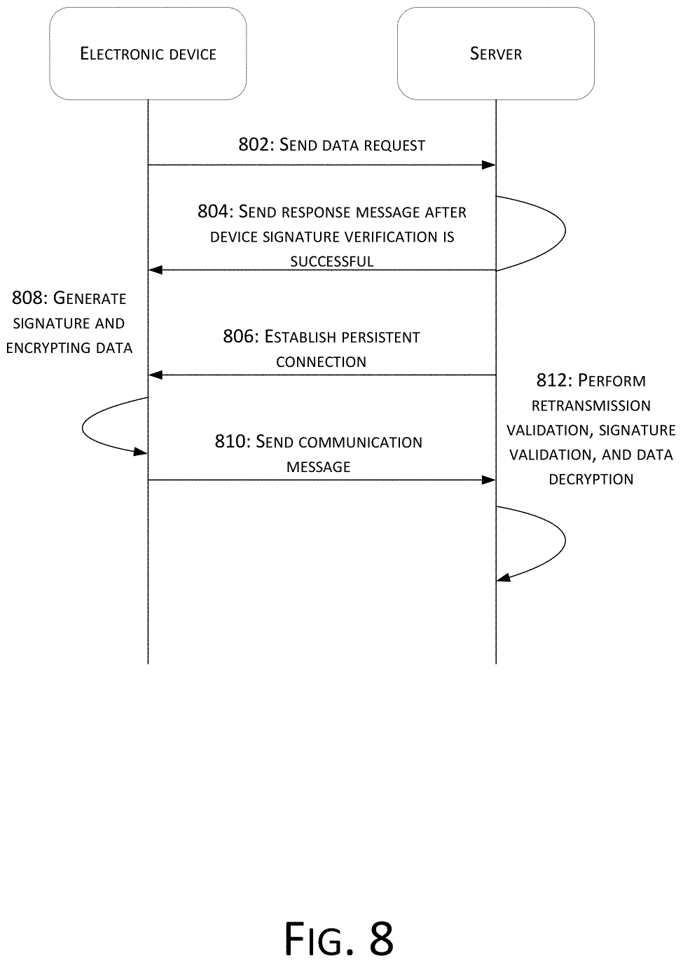

Referring to FIG. 8, a schematic diagram of interaction between an electronic device and a server according to an example embodiment of the present disclosure is shown.

802: the electronic device sends a data request to the server.

The encryption authentication module of the electronic device may obtain a device identifier and a device key from the chip, then generate a device signature based on the device key, the device identifier, and a time stamp, then generate a data request based on the device signature, the device identifier, and the time stamp, and then send the data request by a UDP short connection. The short connection may use CoAP, and be encrypted based on DTLS.

804: the server sends response message after the device signature verification is successful. The server authenticates the device signature based on the data request, generates response information based on a session parameter after the device signature authentication is successful, and sends the response information to the electronic device.

The distributed authentication module of the server may calculate a signature based on restful of the CoAP, and based on the data request, compare the calculated signature with the device signature, generate a token of a current session and a session parameter of an associated communication key after the device signature verification is successful, generate the response information based on the session parameter, and send the response information to the electronic device.

806: a persistent connection is established between the electronic device and the server.

The data application module of the electronic device may keep a TCP persistent connection with the server, i.e., establish a persistent connection with the server by using the token obtained by the encryption authentication module, and perform encryption and decryption by using an encryption authentication module function in subsequent data transmission. The communication protocol parsing module of the server may be configured to perform session authentication based on TCP. After the authentication is successful, the TCP persistent connection with the electronic device is established and kept.

After the persistent connection is established, the server and the electronic device may perform transmission interaction of the encrypted service data. That is, the electronic device may send the encrypted service data to the server, and the server may also send the encrypted service data to the electronic device. The case where the server receives encrypted data sent by the electronic device is described as an example.

808: the electronic device obtains service data, generates a message signature based on the service data and the communication key, and encrypts the service data to obtain a corresponding communication message.

The data application module of the electronic device may obtain the service data, generate the message signature based on the function provided by the encryption authentication module, and encrypt the service data, to obtain the corresponding communication message.

810: the electronic device sends the communication message to the server.

812: the server performs retransmission validation and message signature validation on the communication message and decryption processing on the service data.

The communication protocol parsing module of the server may perform retransmission validation based on the time stamp, and message signature validation of a payload of the communication message after receiving the communication message, and may decrypt the encrypted service data, to facilitate subsequent processing.

In the example embodiment of the present disclosure, a stand-alone encryption authentication module is configured, and hardware is provided to improve and guarantee the device key security, so that application modules at upper and intermediate layers of the system are only responsible for data transmission without sensing secret key information, thereby contributing to security protection of delivery processes of different module manufacturers, and moreover the overhead of a reconnection process may be reduced because only TCP handshake instead of authentication is required each time.

Based on a TCP plaintext message, the present example embodiment additionally provides the time information, the signature, the encryption, and other processing, and a refreshing strategy combining validation and bloomFilter is performed at the server side to prevent replay attack of data, and messages are effectively prevented from being tampered by signature validation, encryption, and decryption.

Encrypted communication interaction between the electronic device and the server is implemented in the above description. In practical processing, such a technological conception of encrypted communication may be applied to various scenarios. For example, it is not limited to a persistent connection established between the electronic device and the server, and a connection type, such as a short connection, between various clients and servers may also be used. For another example, a secret key of the communication message may be preset at an electronic device side without the need for authentication by the server before transmission; or, when the server requests for establishing a session, the server assigns a session identifier to the device in real time.

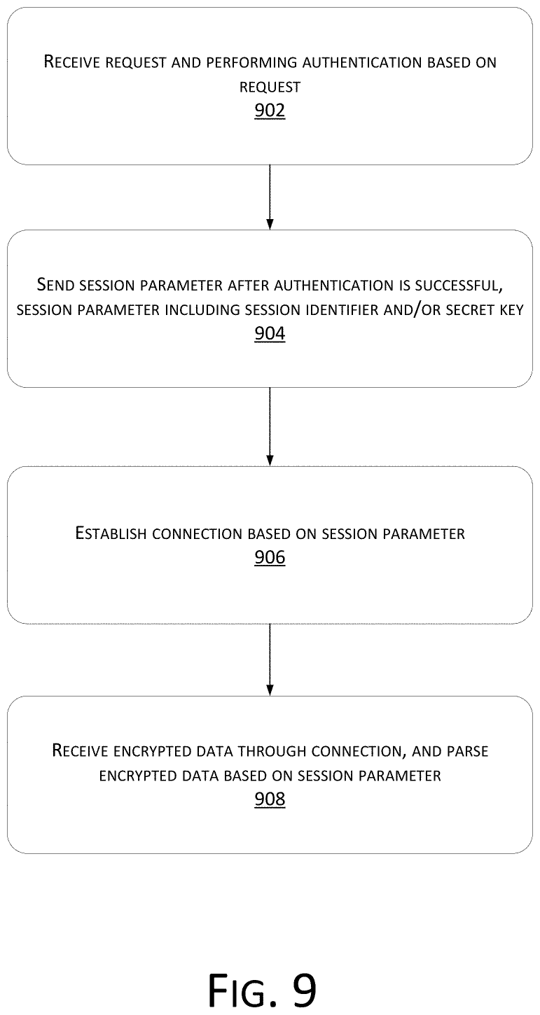

In an example, the method for data communication includes the following steps: Referring to FIG. 9, a step flowchart of an example method for data communication according to an example embodiment of the present disclosure is shown, which may include the following steps:
Step 902: receiving a request and performing authentication based on the request.
Step 904: sending a session parameter after the authentication is successful, the session parameter including a session identifier and/or a secret key.
Step 906: establishing a connection based on the session parameter.
Step 908: receiving encrypted data through the connection, and parsing the encrypted data based on the session parameter.

A device (such as a server, or an electronic device) may receive the request. The request is used to perform authentication, such as security authentication for the device and data. Based on different to-be-authenticated contents, the request may carry different request parameters. Then, the device executes a corresponding type of authentication based on a corresponding request parameter, such as authentication of a device identifier, a MAC address, etc., for determining whether the device is a registered device (such as the device passing signature authentication in the foregoing example embodiment), and authentication for determining whether a user is a known user, such as a registered user.

After the authentication is successful, the session parameter may be obtained and then sent. For example, response information carrying the session parameter is generated, and then the response information is transmitted. The response information may be used for feeding back the successful authentication and returning the session parameter. The session parameter is used for configuring connections for secure transmission, such as a short connection, or a persistent connection. The session parameter includes the session identifier and/or the secret key. The session identifier may be used for establishing a session, or notifying the electronic device to establish a connection, such as a session. The secret key may be a secret key required for communication after connection, or a secret key required by other devices for data authentication.

Then, the connection may be established. The connection may be established based on the session identifier. For example, when no session identifier is present in the session parameter, a request for assigning the session identifier after connection and establishing the connection may be made, and if the session identifier is present in the session parameter, then a request for establishing the connection directly based on the session identifier and performing authentication may be made.

The session parameter may have the secret key, so that during the subsequent data interaction, the secret key may be used for various kinds of security processing, such as encryption processing, decryption processing, and/or signature processing. If the session parameter does not have the secret key, then the secret key may be obtained in a subsequent process, such as the process of establishing a connection, or the secret key may be pre-stored in the device, or the secret key may be obtained in various scenarios as required. Therefore, the encrypted data received through the connection may be parsed by using the secret key, such as decrypting data, and verifying a signature; or the to-be-transmitted data may also be encrypted by using the secret key, or provided with a signature to obtain the encrypted data, and the encrypted data is then transmitted through the connection.

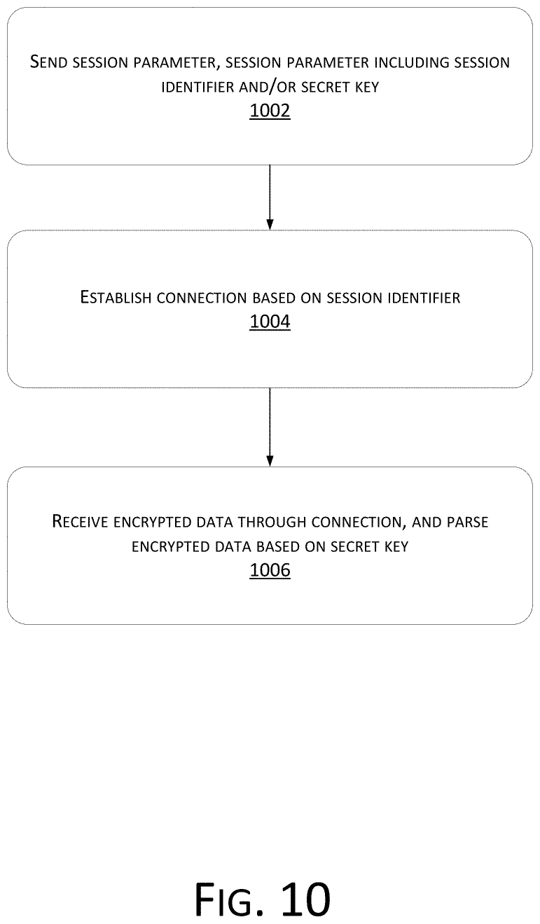

In another example, the method for data communication includes the following steps: Referring to FIG. 10, a step flowchart of another example method for data communication according to an example embodiment of the present disclosure is shown, which may include the following steps:
Step 1002: sending a session parameter, the session parameter including a session identifier and/or a secret key.
Step 1004: establishing a connection based on the session identifier.
Step 1006: receiving encrypted data through the connection, and parsing the encrypted data based on the secret key.

The device (such as a server or an electronic device) may send the session parameter. The session parameter is used for configuring connections for secure transmission, such as a short connection, or a persistent connection. The session parameter may include the session identifier and/or the secret key. The session identifier may be used for establishing a session, or notifying the electronic device to establish a connection, such as a session. The secret key may be a secret key required for communication after connection, or a secret key required by other devices for data authentication.

Then, the connection may be established based on the session parameter. For example, the connection may be established based on the session identifier. For example, when no session identifier is present in the session parameter, a request for assigning the session identifier after connection and establishing the connection may be made, and if the session identifier is present in the session parameter, then a request for establishing the connection directly based on the session identifier and performing authentication may be made.

The session parameter may have the secret key, so that during subsequent data interaction, the secret key may be used for various kinds of security processing, such as encryption processing, decryption processing, and/or signature processing. If the session parameter does not have the secret key, then the secret key may be obtained in a subsequent process, such as the process of establishing a connection, or the secret key may be pre-stored in the device, or the secret key may be obtained in various scenarios as required. Therefore, the encrypted data received through the connection may be parsed by using the secret key, such as decrypting data, and verifying a signature; or the to-be-transmitted data may also be encrypted by using the secret key, or provided with a signature to obtain the encrypted data, and the encrypted data is then transmitted through the connection.

Thus, the session parameter may be transmitted between various devices to establish the connection, and the encrypted data may be transmitted through the connection. The session identifier may be obtained from the session parameter to establish the connection based on the session identifier, or obtained in a process of establishing the connection based on the session parameter. The secret key may be used for encryption processing and decryption processing of data, signature setting, signature validation, or the like during transmission through the connection, thus ensuring the security of the data transmitted through the connection.

It should be noted that, for the method example embodiments, for the ease of description, the example embodiments are all expressed as combinations of a series of actions, but those skilled in the art should understand that the example embodiments of the present disclosure are not limited by the described sequences of actions, because some steps may be performed in other sequences or in parallel according to the example embodiments of the present disclosure. Then, those skilled in the art should further understand that the example embodiments described in the specification are all preferred example embodiments, and the involved actions are not necessarily required by the example embodiments of the present disclosure.

On the basis of the above example embodiments, the present example embodiment further provides an apparatus for data communication, which is applied to a server.

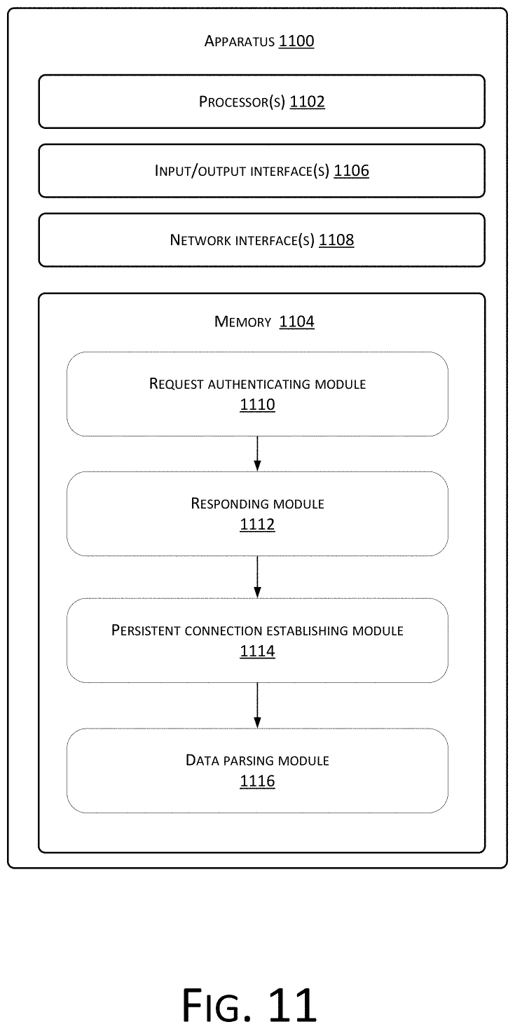

Referring to FIG. 11, a structural block diagram of an example embodiment of an apparatus 1100 for data communication of the present disclosure is shown. As shown in FIG. 11, the apparatus 1100 includes one or more processor(s) 1102 or data processing unit(s) and memory 1104. The apparatus 1100 may further include one or more input/output interface(s) 1106 and one or more network interface(s) 1108. The memory 1104 is an example of computer readable medium or media.

The computer readable medium includes non-volatile and volatile media as well as movable and non-movable media, and may store information by means of any method or technology. The information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

The memory 1104 may store therein a plurality of modules or units as follows:

a request authenticating module 1110 configured to receive a data request and perform device authentication based on the data request;

a responding module 1112 configured to send a session parameter after the device authentication is successful, the session parameter including a session identifier and a communication key;

a persistent connection establishing module 1114 configured to establish a persistent connection based on the session identifier; and

a data parsing module 1116 configured to receive encrypted service data through the persistent connection, and parse the encrypted service data based on the communication key.

For example, device authentication may be performed based on a data request, thereby determining a trusted device, and after the device authentication is successful, a session parameter is sent, the session parameter here includes a session identifier and a communication key, then a persistent connection may be established based on the session identifier; therefore, data communication is maintained through the persistent connection, and data transmission is carried out without reconnection, thus effectively reducing the resource consumption; moreover, encrypted service data transmitted through the persistent connection may be parsed by using the communication key, thus ensuring the service data security.

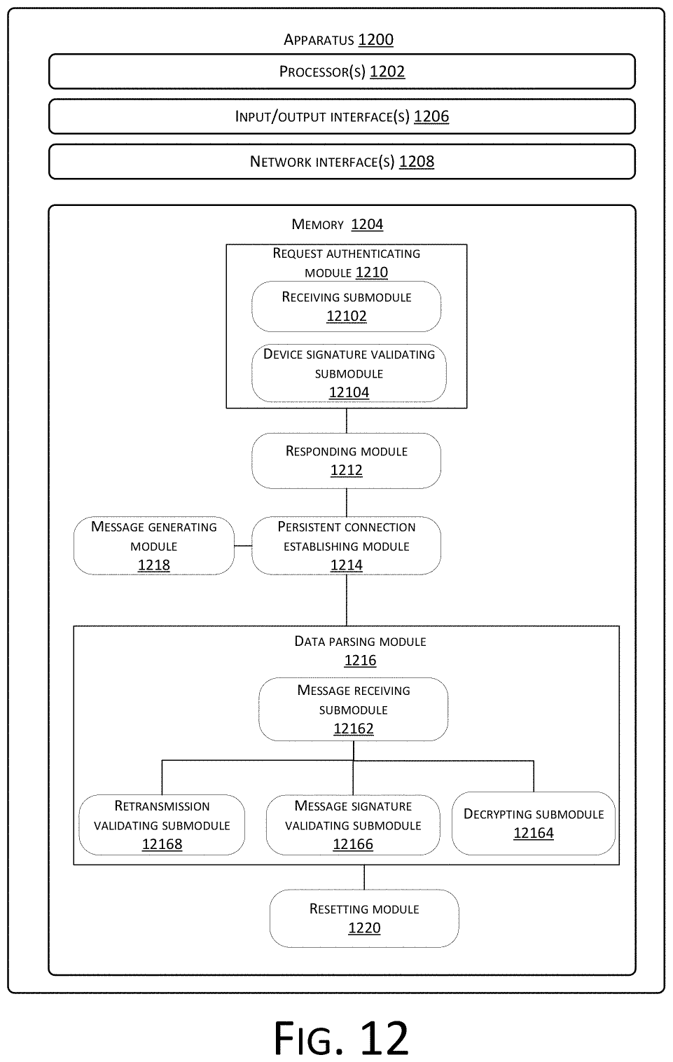

Referring to FIG. 12, a structural block diagram of an alternative example embodiment of an apparatus 1200 for data communication of the present disclosure is shown. As shown in FIG. 12, the apparatus 1200 includes one or more processor(s) 1202 or data processing unit(s) and memory 1204. The apparatus 1200 may further include one or more input/output interface(s) 1206 and one or more network interface(s) 1208. The memory 1204 is an example of computer readable medium or media.

The memory 1204 may store therein a plurality of modules or units as follows:

a request authenticating module 1210 configured to receive a data request and perform device authentication based on the data request;

a responding module 1212 configured to send a session parameter after the device authentication is successful, the session parameter including a session identifier and a communication key, i.e., obtain a session parameter, generate corresponding response information, and send the response information;

a persistent connection establishing module 1214 configured to establish a persistent connection based on the session identifier;

a data parsing module 1216 configured to receive encrypted service data through the persistent connection, and parse the encrypted service data based on the communication key;

a message generating module 1218 configured to encrypt the service data in accordance with an encryption algorithm, and use the encrypted service data and the message signature to constitute the communication message; and

a resetting module 1220 configured to reset the validation set, if a reset condition is met.

For example, the request authenticating module 1210 includes the following submodules:

a receiving submodule 12102 configured to receive a data request; and

a device signature validating submodule 12104 configured to obtain a device signature from the data request, and calculate a first verification signature based on the data request; determine whether the calculated first verification signature is consistent with the obtained device signature; determine that the device authentication is successful if the calculated first verification signature is consistent with the obtained device signature; and determine that the device authentication is not successful if the calculated first verification signature is not consistent with the obtained device signature.

The device signature validating submodule 11024 is configured to obtain a device identifier and time information from the data request; use the device identifier and the time information as signature contents, and obtain a device key as a signature key; and calculate the first verification signature based on the signature key and the signature contents.

The persistent connection establishing module 1214 is configured to receive a session establishment message, and obtain the session identifier from the session establishment message; determine whether an electronic device connection is trusted based on the session identifier; and establish the corresponding persistent connection if the electronic device connection is trusted.

The data parsing module 1216 includes the following submodules:

a message receiving submodule 12162 configured to receive a communication message through the persistent connection, the communication message including the encrypted service data;

a decrypting submodule 12164 configured to decrypt the encrypted service data;

a message signature validating submodule 12166 configured to validate a message signature of the communication message; and

a retransmission validating submodule 12168 configured to validate whether the communication message is a received message based on the time information; discard the communication message if the communication message is the received message; and update a corresponding validation set if the communication message is an unreceived message.

After receiving the communication message through the persistent connection, the message receiving submodule 12162 subsequently may execute at least one of data decryption, signature validation, or replay validation, and does not limit an execution sequence of different parsing and validation processes. Therefore, following the message receiving submodule 12162, the execution triggering sequence of any one or more submodules of the decrypting module 12164, the message signature validating submodule 12166 and the retransmission validating submodule 12168 may be determined as required. For example, following the message receiving submodule 12162, the retransmission validating submodule 12168 is triggered, and then the message signature validating submodule 12166 and the decrypting submodule 12164 are triggered.

The retransmission validating submodule 12168 is configured to obtain the time information from the communication message, and calculate a hash value corresponding to the time information; determine whether the hash value is in the validation set; determine that the communication message is the received message if the hash value is in the validation set; and determine that the communication message is the unreceived message if the hash value is not in the validation set.

The decrypting submodule 12164 is configured to decrypt the service data by using the communication key in accordance with a decryption algorithm to obtain the corresponding service data.

The message signature validating submodule 12166 is configured to obtain the message signature from the communication message, and calculate a second verification signature based on the communication message; determine whether the calculated second verification signature is consistent with the obtained message signature; determine that the message signature validation is successful if the calculated second verification signature is consistent with the obtained message signature; and determine that the message signature validation is not successful if the calculated second verification signature is not consistent with the obtained message signature.

The message signature validating submodule 12166 is configured to obtain a communication parameter and the time information from the communication message; use the communication parameter and the time information as the signature contents, and obtain the communication key as the signature key; and calculate the second verification signature based on the signature key and the signature contents.

On the basis of the above example embodiments, the present example embodiment further provides an apparatus for data communication, which is applied to an electronic device.

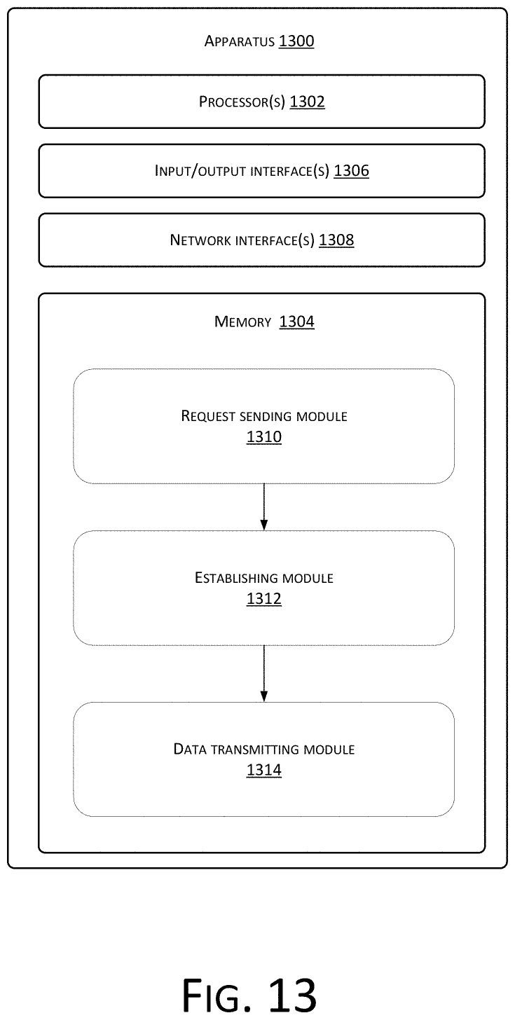

Referring to FIG. 13, a structural block diagram of an example embodiment of another apparatus 1300 for data communication of the present disclosure is shown. As shown in FIG. 13, the apparatus 1300 includes one or more processor(s) 1302 or data processing unit(s) and memory 1304. The apparatus 1300 may further include one or more input/output interface(s) 1306 and one or more network interface(s) 1308. The memory 1304 is an example of computer readable medium or media.

The memory 1304 may store therein a plurality of modules or units as follows:

a request sending module 1310 configured to send a request for device authentication, and receive a session parameter after device authentication is successful, the session parameter including a session identifier and a communication key;

an establishing module 1312 configured to establish a persistent connection based on the session identifier; and

a data transmitting module 1314 configured to transmit, through the persistent connection, service data encrypted by using the communication key.

For example, device authentication may be performed based on a data request, thereby determining a trusted device, and after the device authentication is successful, a session parameter is sent, the session parameter here includes a session identifier and a communication key, then a persistent connection may be established based on the session identifier; therefore, data communication is maintained through the persistent connection, and data transmission is carried out without reconnection, thus effectively reducing the resource consumption; moreover, encrypted service data transmitted through the persistent connection may be parsed by using the communication key, thus ensuring the service data security.

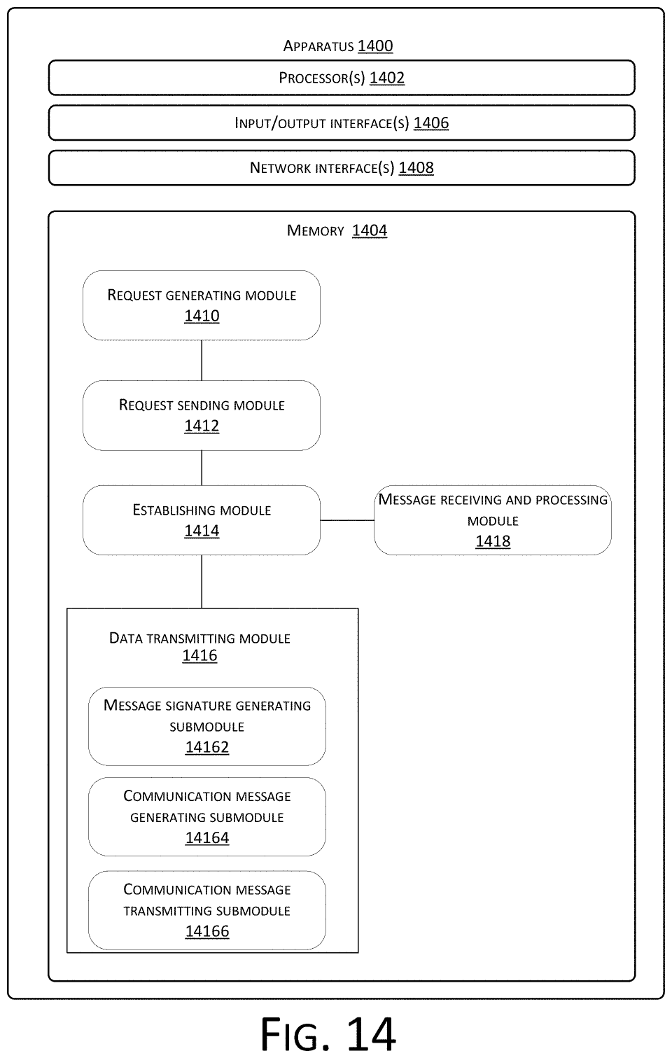

Referring to FIG. 14, a structural block diagram of an alternative example embodiment of another apparatus 1400 for data communication of the present disclosure is shown: As shown in FIG. 14, the apparatus 1400 includes one or more processor(s) 1402 or data processing unit(s) and memory 1404. The apparatus 1400 may further include one or more input/output interface(s) 1406 and one or more network interface(s) 1408. The memory 1404 is an example of computer readable medium or media.

The memory 1404 may store therein a plurality of modules or units including:

a request generating module 1410 configured to determine a device key as a signature key, and determine a device identifier and time information as signature contents; calculate a device signature based on the signature key and the signature contents; and use the device signature and the signature contents to constitute request parameters, and generate the corresponding request for device authentication;

a request sending module 1412 configured to send a request for device authentication, and receive a session parameter after device authentication is successful, the session parameter including a session identifier and a communication key;

an establishing module 1414 configured to establish a persistent connection based on the session identifier;

a data transmitting module 1416 configured to transmit, through the persistent connection, service data encrypted by using the communication key; and

a message receiving and processing module 1418 configured to receive the communication message through the persistent connection, and verify the message signature of the communication message based on the communication key; and decrypt the communication message by using the communication key after the message signature verification is successful.

The establishing module 1414 is configured to generate a session establishment message based on the session identifier, and send the session establishment message to verify that a session is trusted and establish the corresponding persistent connection.

The data transmitting module 1416 includes the following submodules:

a message signature generating submodule 14162 configured to determine a corresponding message signature based on a communication parameter of the service data and the communication key;

a communication message generating submodule 14164 configured to encrypt the service data in accordance with an encryption algorithm, and use encrypted service data and the message signature to constitute a communication message; and

a communication message transmitting submodule 14166 configured to transmit the communication message through the persistent connection.

The message signature generating submodule 14162 is configured to use the communication parameter of the service data and the time information as the signature contents, and use the communication key as the signature key; and calculate the corresponding message signature based on the signature key and the signature contents.

The communication message generating submodule 14164 is configured to encrypt the service data by using the communication key in accordance with the encryption algorithm to obtain the encrypted service data; and add the encrypted service data to the communication message, and add the message signature, the communication parameter, and the time information to a payload of the communication message.

An example embodiment of the present disclosure further provides a system for data communication, including an electronic device and a server, wherein the electronic device includes the apparatus for data communication according to the corresponding example embodiments in the above FIG. 8 and FIG. 9; and the server includes the apparatus for data communication according to the corresponding example embodiments in the above FIG. 10 and FIG. 11. The partitioning approach of corresponding modules in the electronic device and the server in the present example embodiment are different from that in the above FIG. 6, but both provide available modular structures of a device, which is specifically determined as required.

On the basis of the above example embodiments, an example embodiment of the present disclosure further provides an apparatus for data communication, which is applied to various devices, such as an electronic device and a server.

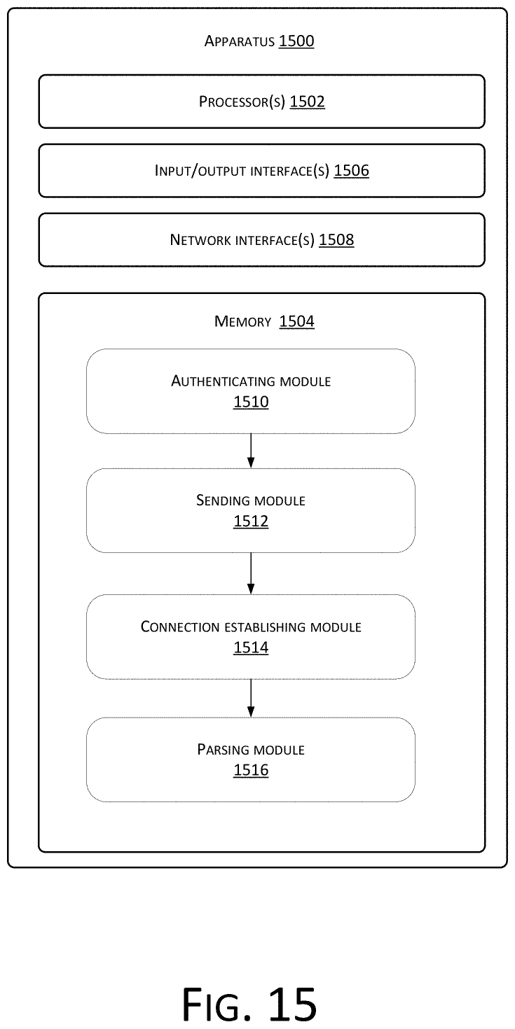

Referring to FIG. 15, a structural block diagram of an example apparatus 1500 for data communication in an example embodiment of the present disclosure is shown. As shown in FIG. 15, the apparatus 1500 includes one or more processor(s) 1502 or data processing unit(s) and memory 1504. The apparatus 1500 may further include one or more input/output interface(s) 1506 and one or more network interface(s) 1508. The memory 1504 is an example of computer readable medium or media.

The memory 1504 may store therein a plurality of modules or units as follows:

an authenticating module 1510 configured to receive a request and perform authentication based on the request;

a sending module 1512 configured to send a session parameter after the authentication is successful, the session parameter including a session identifier and/or a secret key;

a connection establishing module 1514 configured to establish a connection based on the session parameter; and

a parsing module 1516 configured to receive encrypted data through the connection, and parse the encrypted data based on the session parameter.

On the basis of the above example embodiments, an example embodiment of the present disclosure further provides an apparatus for data communication, which is applied to various devices, such as an electronic device and a server.

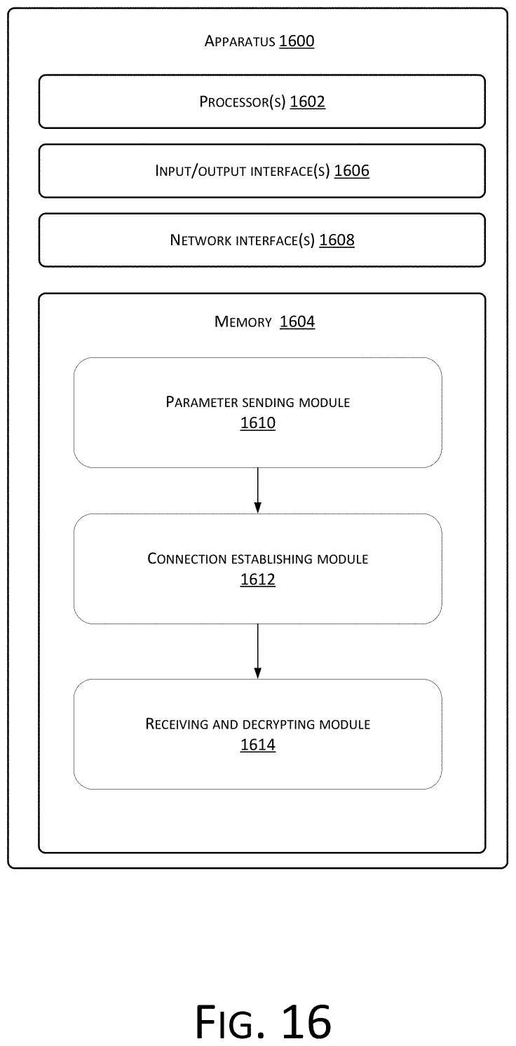

Referring to FIG. 16, a structural block diagram of another example apparatus 1600 for data communication in an example embodiment of the present disclosure is shown. As shown in FIG. 16, the apparatus 1600 includes one or more processor(s) 1602 or data processing unit(s) and memory 1604. The apparatus 1600 may further include one or more input/output interface(s) 1606 and one or more network interface(s) 1608. The memory 1604 is an example of computer readable medium or media.

The memory 1604 may store therein a plurality of modules or units as follows:

a parameter sending module 1610 configured to send a session parameter, the session parameter including a session identifier and/or a secret key;

a connection establishing module 1612 configured to establish a connection based on the session parameter; and

a receiving and decrypting module 1614 configured to receive encrypted data through the connection and parse the encrypted data based on the session parameter.

An example embodiment of the present disclosure further provides a non-volatile readable storage medium. The storage medium stores one or more modules (programs). The one or more modules, when applied to a device, cause the device to execute instructions of steps of the methods in the example embodiments of the present disclosure.

An example embodiment of the present disclosure provides one or more computer readable media, storing computer-readable instructions thereon, wherein the computer-readable instructions, when executed by one or more processors, causes an electronic device to implement the method according to one or more of the above example embodiments. An example embodiment of the present disclosure further provides one or more computer readable media, storing computer-readable instructions thereon, wherein the computer-readable instructions, when executed by one or more processors, causes a server to implement the method according to one or more of the above example embodiments. An example embodiment of the present disclosure further provides one or more computer readable media, storing computer-readable instructions thereon, wherein the computer-readable instructions, when executed by one or more processors, causes a device to implement the method according to one or more of the above example embodiments.

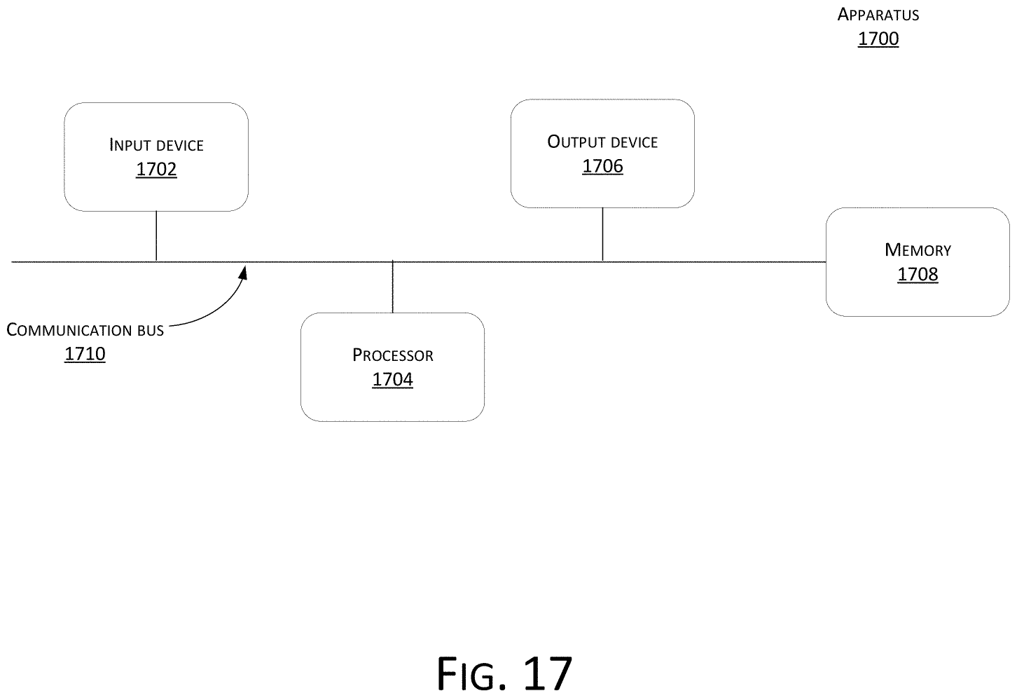

FIG. 17 is a schematic diagram of a hardware structure of an apparatus provided by an example embodiment of the present disclosure. The apparatus may be an electronic device, a service, and the like. As shown in FIG. 17, an apparatus 1700 may include an input device 1702, a processor 1704, an output device 1706, a memory 1708, and at least one communication bus 1710. The communication bus 1710 is configured to implement a communication connection between elements. The memory 1708 may include a high-speed Random-Access Memory (RAM), and may further include a Non-Volatile Memory (NVM), such as at least one disk memory. The memory 1708 may store various programs for completing various processing functions, and implementing steps of the methods of the present example embodiment.

For example, the processor 1704 may be implemented as, for example, a Central Processing Unit (CPU for short), an Application Specific Integrated Circuit (ASIC), a Digital Signal Processor (DSP), a Digital Signal Processing Device (DSPD), a Programmable Logic Device (PLD), a Field Programmable Gate Array (FPGA), a controller, a microcontroller, a microprocessor, or other electronic elements. The processor 1704 is coupled to the input device 1702 and the output device 1706 through a wired or wireless connection.

For example, the input device 1702 may include various input devices, for example, include at least one of a user oriented user interface, a device oriented device interface, a software-programmable interface, a camera, or a sensor. For example, the device oriented device interface may be a wired interface for data transmission between devices, or a hardware insertion interface (e.g., a USB interface, or a serial port) for data transmission between devices. For example, the user oriented user interface may be, for example, a user oriented control button, a voice input device for receiving a voice input, and a touch sensing device for a user to receive a touch input of the user (e.g., a touch screen, a touch control panel, etc. having a touch sensing function). For example, the software programmable interface may be, for example, an interface for the user to edit or modify a program, such as an input pin interface or an input interface of a chip. For example, the apparatus 1700 may also include a transceiver (not shown in FIG. 17), which may be an RF transceiver chip having a communication function, a baseband processing chip, a transceiver antenna, and the like. An audio input device, such as a microphone, may receive voice data. The output device 1706 may include an output device, such as a display, and a sound system.

In the present example embodiment, the processor of the device includes various modules configured to execute functions of the apparatus for data communication in various devices. The above example embodiments may be referred to for the specific functions and technical effects. The description is not repeated here.

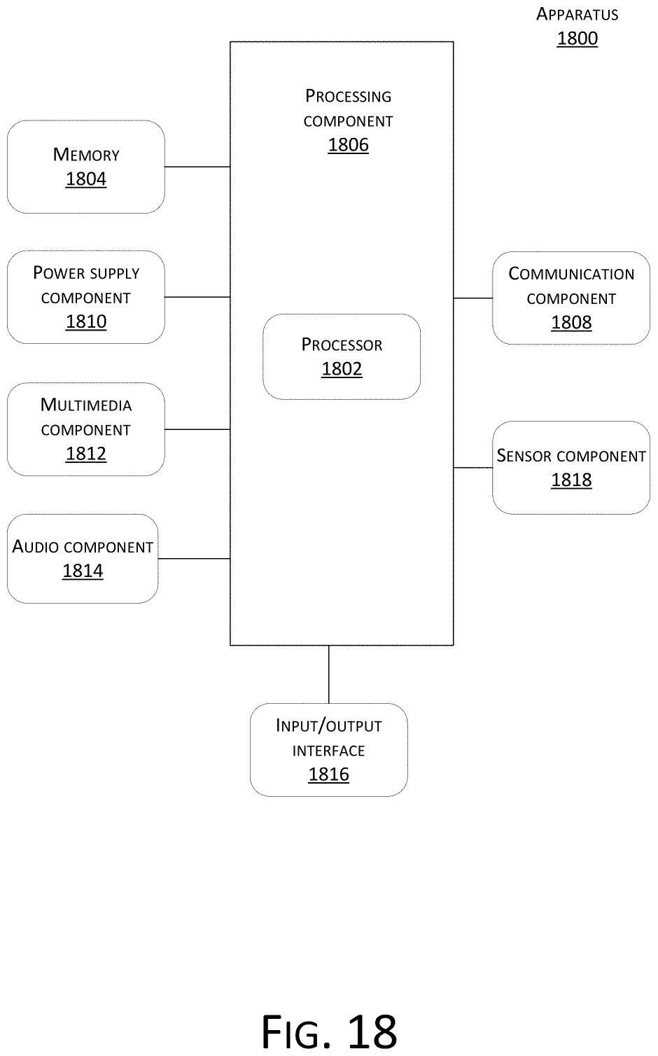

FIG. 18 is a schematic diagram of a hardware structure of an apparatus 1800 provided by another example embodiment of the present disclosure. FIG. 18 is an example embodiment of FIG. 17 in an implementation process. As shown in FIG. 18, an apparatus 1800 of the present example embodiment includes a processor 1802 and a memory 1804.

The processor 1802 is configured to execute a computer program code stored in the memory 1804 to implement the method for data communication of FIG. 1 to FIG. 10 in the above example embodiments.

The memory 1804 is configured to store various types of data to support operations of the device. Examples of such data include instructions of any application program or method for operations of the device, such as a message, an image, or a video. The memory 1804 may include an RAM, and may further include an NVM, such as at least one disk memory.

For example, the processor 1802 is configured in a processing component 1806. The device may further include: a communication component 1808, a power supply component 1810, a multimedia component 1812, an audio component 1814, an input/output interface 1816, and/or a sensor component 1818. Components included in the apparatus 1800 are configured based on actual requirements, which will not be limited in the present example embodiment.

The processing component 1806 generally controls overall operation of the device. The processing component 1806 may include one or more processors 1802 configured to execute instructions, to complete all or parts of steps of the methods of the above FIG. 1 to FIG. 10. Moreover, the processing component 1806 may include one or more modules to facilitate interaction between the processing component 1806 and other assemblies. For example, the processing component 1806 may include a multimedia module to facilitate interaction between the multimedia component 1812 and the processing component 1806.

The power supply component 1810 provides electric power for various assemblies of the device. The power supply component 1810 may include a power management system, one or more power supplies, and other assemblies associated with generation, management and distribution of power for the device.

The multimedia component 1812 includes a display screen providing an output interface between the device and a user. In some example embodiments, the display screen may include a liquid crystal display (LCD) and a touch panel (TP). If the display screen includes a touch panel, the display screen may be implemented as a touch screen to receive an input signal from the user. The touch panel includes one or more touch sensors to sense touch, swipes and gestures on the touch panel. The touch sensor may not only sense the boundary of a touch or swipe action, but also detect a duration and a pressure associated with the touch or swipe operation.

The audio component 1814 is configured to output and/or input an audio signal. For example, the audio component 1814 includes a microphone (MIC). When the device is in an operating mode, such as a voice recognition mode, the microphone is configured to receive an outside audio signal. The received audio signal may be further stored in the memory 1804 or sent via the communication component 1808. In some example embodiments, the audio component 1814 further includes a speaker configured to output an audio signal.

The input/output interface 1816 is configured to provide an interface between the processing component 1806 and a peripheral interface module. The peripheral interface module may be a click wheel, a button, or the like. These buttons may include, but are not limited to: a volume button, a start button, and a lock button.

The sensor component 1818 includes one or more sensors configured to provide state evaluation of the device in various aspects. For example, the sensor component 1818 may detect on/off state of the device, relative location of the assemblies, and existence or non-existence of contact between the user and the device. The sensor component 1818 may include a proximity sensor configured to detect existence of a nearby object without any physical contact, including detecting a distance between the user and the device. In some example embodiments, the sensor component 1818 may further include a camera and the like.

The communication component 1808 is configured to facilitate wired or wireless communication between the device and other devices. The device may be connected to a wireless network based on a communication standard, such as WiFi, 2G, or 3G, or a combination thereof. In one example embodiment, the device may include a SIM card slot. The SIM card slot is configured to insert a SIM card, so that the device may log in a GPRS network, and establish communication with the server via the Internet.

As may be seen from the above, the communication component 1808, the audio component 1814, the input/output interface 1816, and the sensor component 1818 involved in the example embodiment of FIG. 10 each may be used as an implementation of the input device in the example embodiment of FIG. 17.

An example embodiment of the present disclosure provides an electronic device, including: one or more processors; and one or more computer readable media storing computer-readable instructions thereon, wherein the computer-readable instructions, when executed by the one or more processors, causes the electronic device to implement the method according to one or more example embodiments of the present disclosure.

An example embodiment of the present disclosure further provides a server, including: one or more processors; and one or more computer readable media storing computer-readable instructions thereon, wherein the computer-readable instructions, when executed by the one or more processors, causes the server to implement the method according to one or more example embodiments of the present disclosure.

An example embodiment of the present disclosure further provides a device, including: one or more processors; and one or more computer readable media storing computer-readable instructions thereon, wherein the computer-readable instructions, when executed by the one or more processors, causes the server to implement the method according to one or more example embodiments of the present disclosure.

Since the apparatus example embodiments are substantially similar to the method example embodiments, their description is relatively simple, and a portion of description on the example embodiments of the method may be referred to for the relevant content.

Various example embodiments in the present specification are described in a progressive way. Each example embodiment mainly illustrates differences from other example embodiments. Identical or similar portions between the example embodiments may be mutually referred to.

The example embodiment of the present disclosure is described with reference to the flowcharts and/or block diagrams of the method, the terminal device (system), and the computer program product according to the example embodiments of the present disclosure. It should be understood that each process and/or block in the flowcharts and/or block diagrams, and a combination of processes and/or blocks in the flowcharts and/or block diagrams may be implemented by computer program instructions. The computer program instructions may be provided to a general purpose computer, a special purpose computer, an embedded processor, or a processor of other programmable data processing terminal device to produce a machine, such that the computer-readable instructions executed by a general purpose computer or the processor of other programmable data processing terminal device produce an apparatus configured to implement functions specified in one or more processes of the flowcharts and/or one or more blocks of the block diagrams.

These computer program instructions may be further stored in a computer readable memory capable of directing the computer or other programmable data processing terminal device to function by a particular approach, such that the computer-readable instructions stored in the computer readable memory produce an article of manufacture including an instructing apparatus. The instructing apparatus implements the functions specified in one or more processes of the flowcharts and/or one or more blocks of the block diagrams.

The computer program instructions may be further loaded into the computer or other programmable data processing terminal device, such that a series of operation steps are executed on the computer or other programmable terminal device, to produce computer-implemented processing. Therefore, the computer-readable instructions executed on the computer or other programmable terminal device provide steps used for implementing the functions specified in one or more processes of the flowcharts and/or one or more blocks of the block diagrams.

While preferred example embodiments of the example embodiments of the present disclosure have been described, those skilled in the art, once knowing about the concept of basic inventiveness, may make additional variations and modifications to these example embodiments. Therefore, the appended claims are intended to be interpreted as including the preferred example embodiments and all of such variations and modifications falling within the scope of the example embodiments of the present disclosure.

Finally, it should be further noted that the relational terms, such as first and second, herein are merely used to distinguish one entity or operation from another entity or operation without necessarily requiring or implying that there is any such actual relationship or sequence between these entities or operations. Moreover, the terms such as “comprise”, “include” or any other variations thereof are meant to cover the non-exclusive inclusions, such that the process, method, article or terminal device that includes a series of elements not only includes those elements, but also includes other elements that are not explicitly listed, or further includes elements that already exist in such process, method, article or terminal device. In a condition without more constraints, an element defined by the phrase “comprising a . . . ” does not preclude any other similar elements from existing in the process, method, article, or terminal device that includes the element.

A method for data communication, an apparatus for data communication, an electronic device, a server, and a storage medium provided by the present disclosure are illustrated above in detail. Herein, the principles and the example embodiments of the present disclosure are set forth in the specific examples, and the above description of the example embodiments is merely used to help understand the method and core ideas of the present disclosure. Meanwhile, those of ordinary skills in the art will make modification in the specific example embodiments and the scope of application based on the idea of the present disclosure. In conclusion, the content of the present specification should not be construed as limiting the present disclosure.

The present disclosure may further be understood with clauses as follows.

Clause 1. A method for data communication, comprising:

receiving a data request and performing device authentication based on the data request;

sending a session parameter after the device authentication is successful, the session parameter comprising a session identifier and a communication key;

establishing a persistent connection based on the session identifier; and

receiving encrypted service data through the persistent connection, and parsing the encrypted service data based on the communication key.

Clause 2. The method according to clause 1, wherein the performing device authentication based on the data request comprises:

obtaining a device signature from the data request, and calculating a first verification signature based on the data request;

determining whether the calculated first verification signature is consistent with the obtained device signature;

determining that the device authentication is successful if the calculated first verification signature is consistent with the obtained device signature; and

determining that the device authentication is not successful if the calculated first verification signature is not consistent with the obtained device signature.

Clause 3. The method according to clause 2, wherein the calculating a first verification signature based on the data request comprises:

obtaining a device identifier and time information from the data request;

using the device identifier and the time information as signature contents, and obtaining a device key as a signature key; and

calculating the first verification signature based on the signature key and the signature contents.

Clause 4. The method according to clause 1, wherein the establishing a persistent connection based on the session identifier comprises:

receiving a session establishment message, and obtaining the session identifier from the session establishment message;

determining whether an electronic device connection is trusted based on the session identifier; and

establishing the corresponding persistent connection if the electronic device connection is trusted.

Clause 5. The method according to clause 1, wherein the receiving encrypted service data through the persistent connection, and parsing the encrypted service data based on the communication key comprises:

receiving a communication message through the persistent connection, the communication message comprising the encrypted service data; and

decrypting the encrypted service data; and/or, validating a message signature of the communication message.

Clause 6. The method according to clause 5, wherein the method further comprises:

validating whether the communication message is a received message based on the time information;

discarding the communication message if the communication message is the received message; and

updating a corresponding validation set if the communication message is an unreceived message.

Clause 7. The method according to clause 6, wherein the validating whether the communication message is a received message based on the time information comprises:

obtaining the time information from the communication message, and calculating a hash value corresponding to the time information;

determining whether the hash value is in the validation set;

determining that the communication message is the received message if the hash value is in the validation set; and

determining that the communication message is the unreceived message if the hash value is not in the validation set.

Clause 8. The method according to clause 5, wherein the decrypting the encrypted service data comprises:

decrypting the service data by using the communication key in accordance with a decryption algorithm to obtain the corresponding service data.

Clause 9. The method according to clause 5, wherein the validating a message signature of the communication message comprises:

obtaining the message signature from the communication message, and calculating a second verification signature based on the communication message;

determining whether the calculated second verification signature is consistent with the obtained message signature;

determining that the message signature validation is successful if the calculated second verification signature is consistent with the obtained message signature; and

determining that the message signature validation is not successful if the calculated second verification signature is not consistent with the obtained message signature.

Clause 10. The method according to clause 9, wherein the calculating a second verification signature based on the communication message comprises:

obtaining a communication parameter and the time information from the communication message;

using the communication parameter and the time information as the signature contents, and obtaining the communication key as the signature key; and

calculating the second verification signature based on the signature key and the signature contents.

Clause 11. The method according to clause 1, wherein the method further comprises: encrypting the service data in accordance with an encryption algorithm, and using the encrypted service data and the message signature to constitute the communication message.

Clause 12. The method according to clause 6 or 7, wherein the method further comprises:

resetting the validation set if a reset condition is met.

Clause 13. A method for data communication, comprising:

sending a request for device authentication, and receiving a session parameter after device authentication is successful, the session parameter comprising a session identifier and a communication key;

establishing a persistent connection based on the session identifier; and

transmitting, through the persistent connection, service data encrypted by using the communication key.

Clause 14. The method according to clause 13, wherein the method further comprises a step of generating the request for device authentication by:

determining a device key as a signature key, and determining a device identifier and time information as signature contents;

calculating a device signature based on the signature key and the signature contents; and

using the device signature and the signature contents to constitute request parameters, and generating the corresponding request for device authentication.

Clause 15. The method according to clause 13, wherein the establishing a persistent connection based on the session identifier comprises:

generating a session establishment message based on the session identifier, and sending the session establishment message to verify that a session is trusted and establish the corresponding persistent connection.

Clause 16. The method according to clause 13, wherein the transmitting, through the persistent connection, service data encrypted by using the communication key comprises:

determining a corresponding message signature based on a communication parameter of the service data and the communication key;

encrypting the service data in accordance with an encryption algorithm, and using the encrypted service data and the message signature to constitute the communication message; and

transmitting the communication message through the persistent connection.

Clause 17. The method according to clause 16, wherein the determining a corresponding message signature based on a communication parameter of the service data and the communication key comprises:

using the communication parameter and the time information of the service data as the signature contents, and using the communication key as the signature key; and calculating the corresponding message signature based on the signature key and the signature contents.

Clause 18. The method according to clause 16, wherein the encrypting the service data in accordance with an encryption algorithm, and using the encrypted service data and the message signature to constitute the communication message comprises:

encrypting the service data by using the communication key in accordance with the encryption algorithm to obtain the encrypted service data; and

adding the encrypted service data to the communication message, and adding the message signature, the communication parameter, and the time information to a payload of the communication message.

Clause 19. The method according to clause 13, wherein the method further comprises:

receiving the communication message through the persistent connection, and verifying the message signature of the communication message based on the communication key; and

decrypting the communication message by using the communication key after the message signature verification is successful.

Clause 20. A method for data communication, comprising:

receiving a request and performing authentication based on the request;

sending a session parameter after the authentication is successful, the session parameter comprising a session identifier and/or a secret key;

establishing a connection based on the session parameter; and

receiving encrypted data through the connection, and parsing the encrypted data based on the session parameter.

Clause 21. A method for data communication, comprising:

sending a session parameter, the session parameter comprising a session identifier and/or a secret key;

establishing a connection based on the session parameter; and

receiving encrypted data through the connection, and parsing the encrypted data based on the session parameter.

Clause 22. An apparatus for data communication, comprising:

a request authenticating module configured to receive a data request and perform device authentication based on the data request;

a responding module configured to send a session parameter after the device authentication is successful, the session parameter comprising a session identifier and a communication key;

a persistent connection establishing module configured to establish a persistent connection based on the session identifier; and

a data parsing module configured to receive encrypted service data through the persistent connection, and parse the encrypted service data based on the communication key.

Clause 23. The apparatus according to clause 22, wherein the request authenticating module comprises:

a device signature validating submodule configured to obtain a device signature from the data request, and calculate a first verification signature based on the data request; determine whether the calculated first verification signature is consistent with the obtained device signature; determine that the device authentication is successful if the calculated first verification signature is consistent with the obtained device signature; and determine that the device authentication is not successful if the calculated first verification signature is not consistent with the obtained device signature.

Clause 24. The apparatus according to clause 23, wherein

the device signature validating submodule is configured to obtain a device identifier and time information from the data request; use the device identifier and the time information as signature contents, and obtain a device key as a signature key; and calculate the first verification signature based on the signature key and the signature contents.

Clause 25. The apparatus according to clause 22, wherein

the persistent connection establishing module is configured to receive a session establishment message, and obtain the session identifier from the session establishment message; determine whether an electronic device connection is trusted based on the session identifier; and establish the corresponding persistent connection if the electronic device connection is trusted.

Clause 26. The apparatus according to clause 22, wherein the data parsing module comprises:

a message receiving submodule configured to receive a communication message through the persistent connection, the communication message comprising the encrypted service data;

a decrypting submodule configured to decrypt the encrypted service data; and

a message signature validating submodule configured to validate a message signature of the communication message.

Clause 27. The apparatus according to clause 26, wherein the data parsing module further comprises:

a retransmission validating submodule configured to validate whether the communication message is a received message based on the time information; discard the communication message if the communication message is the received message; and update a corresponding validation set if the communication message is an unreceived message.

Clause 28. The apparatus according to clause 27, wherein

the retransmission validating submodule is configured to obtain the time information from the communication message, and calculate a hash value corresponding to the time information; determine whether the hash value is in the validation set; determine that the communication message is the received message if the hash value is in the validation set; and determine that the communication message is the unreceived message if the hash value is not in the validation set.

Clause 29. The apparatus according to clause 26, wherein

the decrypting submodule is configured to decrypt the service data by using the communication key in accordance with a decryption algorithm to obtain the corresponding service data.

Clause 30. The apparatus according to clause 26, wherein

the message signature validating submodule is configured to obtain the message signature from the communication message, and calculate a second verification signature based on the communication message; determine whether the calculated second verification signature is consistent with the obtained message signature; determine that the message signature validation is successful if the calculated second verification signature is consistent with the obtained message signature; and determine that the message signature validation is not successful if the calculated second verification signature is not consistent with the obtained message signature.

Clause 31. The apparatus according to clause 30, wherein

the message signature validating submodule is configured to obtain a communication parameter and the time information from the communication message; use the communication parameter and the time information as the signature contents, and obtain the communication key as the signature key; and calculate the second verification signature based on the signature key and the signature contents.

Clause 32. The apparatus according to clause 22, wherein the apparatus further comprises:

a message generating module configured to encrypt the service data in accordance with an encryption algorithm, and use the encrypted service data and the message signature to constitute the communication message.

Clause 33. The apparatus according to clause 27 or 28, wherein the apparatus further comprises:

a resetting module configured to reset the validation set if a reset condition is met.

Clause 34. An apparatus for data communication, comprising:

a request sending module configured to send a request for device authentication, and receive a session parameter after device authentication is successful, the session parameter comprising a session identifier and a communication key;

an establishing module configured to establish a persistent connection based on the session identifier; and

a data transmitting module configured to transmit, through the persistent connection, service data encrypted by using the communication key.

Clause 35. The apparatus according to clause 34, wherein the apparatus further comprises:

a request generating module configured to determine a device key as a signature key, and determine a device identifier and time information as signature contents; calculate a device signature based on the signature key and the signature contents; and use the device signature and the signature contents to constitute request parameters, and generate the corresponding request for device authentication.

Clause 36. The apparatus according to clause 34, wherein

the establishing module is configured to generate a session establishment message based on the session identifier, and send the session establishment message, to authenticate that a session is trusted and establish the corresponding persistent connection.

Clause 37. The apparatus according to clause 34, wherein the data transmitting module comprises:

a message signature generating submodule configured to determine a corresponding message signature based on a communication parameter of the service data and the communication key;

a communication message generating submodule configured to encrypt the service data in accordance with an encryption algorithm, and use encrypted service data and the message signature to constitute a communication message; and

a communication message transmitting submodule configured to transmit the communication message through the persistent connection.

Clause 38. The apparatus according to clause 37, wherein

the message signature generating submodule is configured to use the communication parameter of the service data and the time information as the signature contents, and use the communication key as the signature key; and calculate the corresponding message signature based on the signature key and the signature contents.

Clause 39. The apparatus according to clause 37, wherein

the communication message generating submodule is configured to encrypt the service data by using the communication key in accordance with the encryption algorithm to obtain the encrypted service data; and add the encrypted service data to the communication message, and add the message signature, the communication parameter, and the time information to a payload of the communication message.

Clause 40. The apparatus according to clause 34, wherein the apparatus further comprises:

a message receiving and processing module configured to receive the communication message through the persistent connection, and verify the message signature of the communication message based on the communication key; and decrypt the communication message by using the communication key after the message signature verification is successful.

Clause 41. An apparatus for data communication, comprising:

an authenticating module configured to receive a request and perform authentication based on the request;

a sending module configured to send a session parameter after the authentication is successful, the session parameter comprising a session identifier and/or a secret key;

a connection establishing module configured to establish a connection based on the session parameter; and

a parsing module configured to receive encrypted data through the connection, and parse the encrypted data based on the session parameter.

Clause 42. An apparatus for data communication, comprising:

a parameter sending module configured to send a session parameter, the session parameter comprising a session identifier and/or a secret key;

a connection establishing module configured to establish a connection based on the session parameter; and

a receiving and decrypting module configured to receive encrypted data through the connection, and parse the encrypted data based on the session parameter.

Clause 43. A system for data communication, comprising an electronic device and a server, wherein

the electronic device comprises the apparatus for data communication according to any one of clauses 34-40; and

the server comprises the apparatus for data communication according to any one of clauses 22-33.

Clause 44. An electronic device, comprising:

one or more processors; and

one or more computer readable media storing computer-readable instructions thereon, wherein the computer-readable instructions, when executed by the one or more processors, causes the electronic device to implement the method according to one or more of clauses 1-12.

Clause 45. One or more computer readable media, storing computer-readable instructions thereon, wherein the computer-readable instructions, when executed by one or more processors, causes an electronic device to implement the method according to one or more of clauses 1-12.

Clause 46. A server, comprising:

one or more processors; and

one or more computer readable media storing computer-readable instructions thereon, wherein the computer-readable instructions, when executed by the one or more processors, causes the server to implement the method according to one or more of clauses 13-19.

Clause 47. One or more computer readable media, storing computer-readable instructions thereon, wherein the computer-readable instructions, when executed by one or more processors, causes a server to implement the method according to one or more of clauses 13-19.

Clause 48. An electronic device, comprising:

one or more processors; and

one or more computer readable media storing computer-readable instructions thereon, wherein the computer-readable instructions, when executed by the one or more processors, causes the device to implement the method according to clause 20.

Clause 49. One or more computer readable media, storing computer-readable instructions thereon, wherein the computer-readable instructions, when executed by one or more processors, causes a device to implement the method according to clause 20.

Clause 50. An electronic device, comprising:

one or more processors; and

one or more computer readable media storing computer-readable instructions thereon, wherein the computer-readable instructions, when executed by the one or more processors, causes the device to implement the method according to clause 21.

Clause 51. One or more computer readable media, storing computer-readable instructions thereon, wherein the computer-readable instructions, when executed by one or more processors, causes a device to implement the method according to clause 21.

What is claimed is:

1. A method comprising:
receiving a data request;
performing a device authentication based on the data request;
sending a session parameter after the device authentication is successful, the session parameter comprising a session identifier and a communication key;
establishing a persistent connection based on the session identifier;
receiving encrypted data through the persistent connection; and
parsing the encrypted data based on the communication key.

2. The method of claim 1, wherein the performing the device authentication based on the data request comprises:
obtaining a device signature from the data request;
calculating a first verification signature based on the data request; and
determining that the device authentication is not successful in response to determining that the calculated first verification signature is not consistent with the obtained device signature.

3. The method of claim 1, wherein the performing the device authentication based on the data request comprises:
obtaining a device signature from the data request;
calculating a first verification signature based on the data request; and
determining that the device authentication is successful in response to determining that the calculated first verification signature is consistent with the obtained device signature.

4. The method of claim 3, wherein the calculating the first verification signature based on the data request comprises:
obtaining a device identifier and time information from the data request;
using the device identifier and the time information as signature contents;
obtaining a device key as a signature key; and
calculating the first verification signature based on the signature key and the signature contents.

5. The method of claim 1, wherein the establishing the persistent connection based on the session identifier comprises:
receiving a session establishment message;
obtaining the session identifier from the session establishment message;
determining that an electronic device connection is trusted based on the session identifier; and
establishing the persistent connection.

6. The method of claim 1, wherein:
the receiving the encrypted data through the persistent connection comprises receiving a communication message through the persistent connection, the communication message comprising the encrypted data; and
the parsing the encrypted data based on the communication key comprises decrypting the encrypted data and/or validating a message signature of the communication message.

7. The method of claim 6, further comprising:
validating whether the communication message is a received message based on the time information;
discarding the communication message in response to determining that the communication message is the received message; and
updating a corresponding validation set in response to determining that the communication message is not a received message.

8. The method of claim 7, wherein the validating whether the communication message is the received message based on the time information comprises:
obtaining the time information from the communication message;
calculating a hash value corresponding to the time information;
determining whether the hash value is in a validation set;
determining that the communication message is the received message in response to determining that the hash value is in the validation set; and
determining that the communication message is not the received message in response to determining that the hash value is not in the validation set.

9. The method of claim 6, wherein the decrypting the encrypted data comprises:
decrypting by using the communication key in accordance with a decryption algorithm to obtain the corresponding data.

10. The method of claim 6, wherein the validating the message signature of the communication message comprises:
obtaining the message signature from the communication message;
calculating a second verification signature based on the communication message;
determining whether the calculated second verification signature is consistent with the obtained message signature;
determining that the message signature validation is successful in response to determining that the calculated second verification signature is consistent with the obtained message signature; and
determining that the message signature validation is not successful in response to determining that the calculated second verification signature is not consistent with the obtained message signature.

11. The method of claim 10, wherein the calculating the second verification signature based on the communication message comprises:
obtaining a communication parameter and the time information from the communication message;
using the communication parameter and the time information as the signature contents;
obtaining the communication key as the signature key; and
calculating the second verification signature based on the signature key and the signature contents.

12. The method of claim 1, further comprising:
encrypting the data in accordance with an encryption algorithm; and
using the encrypted data and the message signature to form the communication message.

13. An apparatus comprising:
one or more processors; and
one or more memories storing computer readable instructions that, executable by the one or more processors, cause the one or more processors to perform acts comprising:
sending a request for device authentication;
receiving a session parameter after a device authentication is successful, the session parameter comprising a session identifier and a communication key;
establishing a persistent connection based on the session identifier; and
transmitting, through the persistent connection, data encrypted by using the communication key.

14. The apparatus of claim 13, wherein the acts further comprise generating the request for device authentication, wherein the generating the request for device authentication comprises:
determining a device key as a signature key;
determining a device identifier and time information as signature contents;
calculating a device signature based on the signature key and the signature contents;
using the device signature and the signature contents to form request parameters; and
generating the request for device authentication.

15. The apparatus of claim 13, wherein the establishing the persistent connection based on the session identifier comprises:
generating a session establishment message based on the session identifier; and
sending the session establishment message to verify that a session is trusted and establish the corresponding persistent connection.

16. The apparatus of claim 13, wherein the transmitting, through the persistent connection, the data encrypted by using the communication key comprises:
determining a corresponding message signature based on a communication parameter of the data and the communication key;
encrypting the data in accordance with an encryption algorithm;
using the encrypted data and the message signature to form the communication message; and
transmitting the communication message through the persistent connection.

17. The apparatus of claim 16, wherein the determining the corresponding message signature based on the communication parameter of the data and the communication key comprises:
using the communication parameter and the time information of the data as the signature contents;
using the communication key as the signature key; and
calculating the corresponding message signature based on the signature key and the signature contents.

18. The apparatus of claim 16, wherein:
the encrypting the data in accordance with an encryption algorithm comprises encrypting the data by using the communication key in accordance with the encryption algorithm to obtain the encrypted service data; and
the using the encrypted data and the message signature to form the communication message comprises:
adding the encrypted data to the communication message; and
adding the message signature, the communication parameter, and the time information to a payload of the communication message.

19. The apparatus of claim 13, wherein the acts further comprise:
receiving the communication message through the persistent connection;
verifying the message signature of the communication message based on the communication key; and
decrypting the communication message by using the communication key after the message signature verification is successful.

20. One or more memories storing computer readable instructions that, executable by one or more processors, cause the one or more processors to perform acts comprising:
sending a session parameter, the session parameter comprising a session identifier;
establishing a connection based on the session parameter;
receiving encrypted data through the connection; and
parsing the encrypted data based on the session parameter.
